(19) United States
(12) Patent Application Publication
(10) Pub. No.: US 2017/0236237 A1
(43) Pub. Date: Aug. 17, 2017

(54) METHOD OF SCORING

(71) Applicant: Leon Jurgens SMUTS, (US)

(72) Inventor: Leon Jurgens SMUTS, Kempton Park (ZA)

(21) Appl. No.: 15/514,646

(22) PCT Filed: Sep. 23, 2015
(86) PCT No.: PCT/IB2015/057324

§ 371 Date: Mar. 27, 2017

(30) Foreign Application Priority Data
Sep. 25, 2014 (ZA) 2014/07113

(51) Int. Cl. G06Q 50/34; G06N 5/02

(52) U.S. Cl. CPC G06Q 50/34; G06N 5/022

(57) ABSTRACT

A method of arranging participants' event predictions in a participation event in which multiple participants participate to predict an outcome of the participation event, which method includes receiving a first participant identity registration associated with a first participant, linking the first participant's identity registration with at least one other participant identity registration associated with at least one other participant, receiving event predictions from the first participant and the at least one other participant and collating the event predictions from the first participant with the event predictions from the at least one other participant.

### FIELD OF THE INVENTION

This invention relates to outcome prediction. In particular the invention relates to a method of arranging a participants' event predictions in a participation event in which multiple participants participate to predict an outcome of the participation event, to a method of ranking the participants' level of expertise and to a method of facilitating a challenge between participants, with the emphasis on each element improving player competitiveness and involvement throughout.

### BACKGROUND OF THE INVENTION

The inventor is aware of methods of scoring events based on games of chance. However, there is no method of scoring of which the inventor is aware which provides for ranking of outcomes, but also for ranking of participants to games of chance. In particular, when participants participate in games of chance there is no method of grouping their participation and to rank their performance in an equitable manner.

This application seeks protection for this invention which introduces a new format and structure that will enable the sport of racing, which is currently only a sport for owners, trainers and jockeys, to be offered as a unique sport or sports game to anyone who might be interested in more than only a pure wagering or fantasy league style involvement.

It has to be remembered though that most sports in existence today happened almost spontaneously through casual play and discovery, evolving further through growing involvement and popularity and usually culminating in the drawing up of rules and a formal participation structure.

Most of this happened in an era where sport had little or no commercial value and where participants took part as amateurs, mostly only for fun. It is only much later that sport grew into the commercial giant that it is today, where many sportsmen and sports administrators are now professionals, earning a full time or part time living from plying their trade.

The non-commercial start is one of the reasons why the current range of sport on offer never formed part of any patent applications but also because these activities evolved from public domain participation that excludes it from protection.

This invention seeks protection for this sport gaming activity and potential future sport, labelled Equine X, which could have substantial commercial value, especially as racing which it is predominantly, but not exclusively aimed at has been struggling to reposition itself as a modern and popular activity. Racing, through its current structure, has not been able to attract significant new support, despite extensive marketing efforts over many years. Racing has been around for many decades and even though the industry is facing and has faced mounting challenges it has failed to recognise the marketing, entertainment and commercial value that could be unlocked by the invention and creation of a unique racing sports offering.

The industry has predominantly marketed racing as an attraction through race day exposure and has achieved very little where it could achieve widespread success by focussing efforts on marketing racing as an exciting new activity.

It is only through years of involvement in the financial industry, an extensive practical and academic background in marketing and more importantly an extreme passion for racing and a desire to support the racing industry, that this unique new angle to create a brand new competitive sport or sports gaming racing activity have been pursued.

Many aspects that form part of this invention will lay the foundation for racing to be offered as a competitive sport or sports game for the first time ever, and will offer the most significant new marketing opportunity that the industry has had to date. Equine X will provide fresh growth opportunities for the racing industry by offering potential players an exciting alternative involvement in racing, outside of traditional wagering. This invention makes extensive provision to offer racing as a pure sport or a sports driven game, or sport with different levels of casual wagering or as a toned down wagering offering with sports elements. It also has applications as a new pure wagering format that will provide players with an entertaining introduction to racing that will assist in shortening the necessary skills learning curve that all participants, including punters, need to undergo in order to become proficient players.

Equine X is an exciting format that has been created as a potential stand-alone racing offering and/or to directly or indirectly support and complement the marketing of racing by means of a unique new gaming format and structure that will make racing much more entertaining, appealing and enjoyable to a broader and more diverse group of people.

### An Introduction to Racing

Although horse racing has been around for a very long time there are still frequent debates around classification as a game or a sport and each of these definitions ultimately carries a different set of rules and regulations and different tax implications.

The purpose of this invention is not to add to this debate but rather to provide a significant alternative approach to aid racing in its marketing efforts, as the industry has an extremely disappointing record when it comes to growing the customer and support base and creating new interest in racing.

It should be noted that racing is easily classified as a sport for trainers and jockeys and to a certain extent owners and breeders, as they compete for honours annually throughout the racing season, and these achievements are acknowledged in seasonal logs and award ceremonies each year.

As racing is also heavily dependent on funding from wagering activities the game tag also has substantial relevance as punters or players can only participate by betting on the outcome of races or a series of races.

Some social credentials has been added to racing over time with the introduction of player limited tournaments and a few fantasy style racing games being offered, but all of these efforts have fallen well short of securing sustainable new interest and support for racing.

This invention covers aspects that will introduce various new marketing opportunities for the racing industry by creating and establishing a format with numerous applications either as a pure player sport, a mixture of sport and wagering or pure wagering with a sporting theme.

The objective of this invention is to reach out to a broader and more diverse group of people by providing them with an opportunity to experience the joy of horse and or other racing as a unique competitive activity or sport. This invention will enable people of all ages, income groups, male or female players and single or group participants to take part in a new racing activity for the benefit, preservation and further development of this wonderful traditional pastime.

A number of completely new aspects to racing will be introduced as part of this invention and it will include unique playing elements, characteristics and gaming formats, original distribution offerings, a wagering format and a unique competitive structure that will provide racing with ground breaking sport and sports gaming credentials, to achieve the overall longer term objective of ultimately establishing racing as a modern day sports offering for players, fans and supporters.

Multi-leg games could be considerably more popular and supportive of efforts to market racing, but it suffers from a few critical drawbacks of which an extremely important one is the lack of accessibility and control in these types of games or wagers. Once selections or a bet is placed and the game or wager is underway there is no further opportunity to make adjustments to selections even though there are often important changes that influence, or could influence, the outcome of individual events in a series of events making up the total multi-leg game or wager. A few typical examples in racing that can occur after the start of an event is changes in the weather and/or track, jockey changes, unexpected betting moves, runners that are scratched late due to injury or other reason or a late assessment of the physical appearance or condition of runners in the parade ring or canter down providing pointers, or even a false start or a runner or runners becoming fractious before a race.

For experienced players this has long been a reason for limited involvement in these types of wagers which is a major obstacle in increasing further growth from within, but even more importantly accessibility would make games or wagers far more interesting and enjoyable for new players, which could be a major factor in successfully promoting the sport of racing to a more diverse and new future customer base. Providing an active involvement has many benefits, not least of which is increased exposure to the activity that the player is participating in as well as more enjoyment through greater control in a more interactive environment.

Providing a brand new innovative platform and unique format that will facilitate a more interactive, immersive and entertaining experience by way of comprehensive in-game control will make participation far more entertaining, competitive and considerably more marketable.

Traditional wagering formats severely limit the prospects of any in-game accessibility, as almost all existing formats are elimination based, which means that only those that remain in the game in longer format variations could potentially benefit from the use of a more flexible wagering or playing platform. This game design and others that I am busy developing are all non-elimination based and would be greatly enhanced by a more control friendly player approach. This is a critical development for especially racing, which could have very positive consequences for future wagering and gaming applications and importantly the marketing of racing to a new generation of players.

### SUMMARY OF THE INVENTION

### Dynamic Team Representation

According to one aspect of the invention in a participation event in which multiple participants participate to predict an outcome of the participation event, there is provided a method of arranging the participants' event predictions, which method includes

receiving a first participant identity registration associated with a first participant;

linking the participant's identity registration with at least one other participant identity registration associated with at least one other participant;

receiving event predictions from the first participant and the at least one other participant; and

collating the event predictions from the first participant with the event predictions from the at least one other participant.

Collating the event predictions from the first participant with the event predictions from the at least one other participant may include collating the participants' predictions in groups representing teams, clubs, geographical regions, countries, leagues. The event predictions may thus be collated in these groups.

The method may include the further step of defining qualification requirements to qualify for participation on the various groups on the various levels as well as defining qualification requirements for a representative contribution. The method may thus include ranking the participants in a particular group according to the accuracy of their event predictions. It is to be appreciated that the method may thus provide a method of ranking groups of dissimilar sizes with each other. The ranking may be valid for a predefined period such as a sporting season, a year, a single or a few or multiple events, or the like.

Linking the participant's identity registration with at least one other participant identity registration associated with at least one other participant may include arranging the participants in groups representing teams, clubs, geographical regions, countries, leagues.

The method may include associating a participant identity registration with the identity of the participant and any one or more of a team, a club, a geographical region, a country and a league. The method may thus include the prior step of defining teams, clubs, geographical regions and leagues.

Associating a participant identity registration with the identity of the participant may include placing restrictions on the registration of the identity of the participant.

The step of receiving a first participant identity registration associated with a first participant may include opening a monetary transacting account into which contributions may be deposited and from which payments may be subtracted. In particular, the payments that may be subtracted may include fees, challenge fees, general fees or wagering amounts. Payments that may be deposited may include contributions, prize money and dividends.

The method may include charging a participation fee which may include any one of an initial registration fee and a periodic fee, or both.

### Player Skill Factor (PSF)

According to another aspect of the invention in a participation event in which multiple participants participate to predict an outcome of the participation event, there is provided a method of ranking a participants' level of expertise, which method includes

receiving outcomes from multiple previous events;

calculating for each event an average outcome amongst all participants;

calculating for each event for a participant a deviation between the participant's predicted outcome and the average outcome of the other participants;

obtaining for the participant an average of the total deviations between the participant's predicted outcome and the average outcome of the other participants of all competitive events.

The method may include permitting an administrator/game host/betting operator to select only certain events in a series of events for calculating the average amongst all participants. For example, if the event is a pure wagering event, the administrator/game host/betting operator may be permitted to discard certain outcomes.

The method thus includes expressing a player's calculated level of expertise as an ability rating or factor that can be further utilised as an ability allowance in all or some formats of game play.

### Player Private Challenges

According to another aspect of the invention in a participation event in which multiple participants participate to predict an outcome of the participation event, there is provided a method of facilitating a challenge between participants, which method includes

receiving from a first participant a challenge to the at least one other participant to determine an outcome of an event;

receiving a response from the at least one other participant to participate in the challenge, which response may include any one of acceptance of the challenge, declining of the challenge and raising a new challenge;

evaluating the event outcome in relation to the challenge from the first or at least one other participant upon completion of the event; and

settling the challenge between the first and at least one other participant.

The challenge may include defining a particular amount that is challenged. The method may include receiving from the first participant a challenge directed at a particular at least one other participant (a direct challenge), of may be directed at no particular at least one other participant (an open challenge).

Receiving a response may include assigning a declined status to a challenge which has not been responded to within a particular predefined time limit.

Settling the challenge may include creating a credit commitment on the monetary transacting account described above. Accepting or making a challenge may include subtracting a predefined participation amount from the transacting account or incurring a hold on the value of the challenge. Settling the challenge may include the further step of paying and receiving payment from the respective participants' monetary transacting accounts based on the outcome evaluation.

The method may include a continuous or perpetual challenge between players for events in which they jointly take part.

A challenge may include any one or more of the highest points total between different legs in a series of events, the highest number of points after a selected number of legs in a series of events, the most points for a specific pre-selected number of legs in a series of events, the most points in a single leg of an event, the most points from a specific starting point to a specific finish point in an event, or the most points after completion of all legs of an event or series of events. In events not determined by a point scoring methodology any other predefined determinant or measure of superior performance between two or more players could be used in private challenges.

The method may include an accumulation of different challenges between the same participants. This method is referred to as skins challenges. The method thus includes accumulating the outcomes of different challenges from one leg of an event in a series of events to another leg in the event or the series of events.

The accumulation of different challenges in skins challenges may include accumulating collated event predictions from a number of participants arranged in the teams, clubs, geographical regions, countries, leagues together.

The challenge may include the specification of the monetary value per skin that the participants want to challenge. If the skin ends in a tie, the skin will either be carried over to the next leg or forfeited as per pre-determined challenge conditions or rules. The highest score of a leg will win the skin in the relevant leg. The method may include forfeiting a skin if the skin is not won outright at the end of a series of events. The method may include selecting the highest scores in a collated number of event predictions.

The invention will now be described by way of a non-limiting example only, with reference to the following drawings.

### DRAWINGS

In the drawings:

FIG. 1 shows a standard game-scoring matrix, in accordance with the method of the present invention;

FIG. 1A shows an index based scoring matrix, further in accordance with the invention;

FIG. 2 shows a player skill factor (PSF) allocated to a player, in accordance with the method of the present invention;

FIG. 3 shows an example of a dynamic prize pool, in accordance with a previously disclosed method. This Figure is not described further in the document;

FIG. 4 shows an example of using a PSF in a sport, game or wagering application, in accordance with the method of the present invention;

FIG. 5 shows a number of events scored, in accordance with a previously disclosed method. This Figure is not described further in the document;

FIG. 6 shows a number of events scored taking the PSF into account, in accordance with the method of the present invention;

FIG. 7 shows examples of potential pool splits, in accordance with the method of the present invention;

FIG. 8 shows a standardized scoring matrix and standardized game format, in accordance with the method of the present invention;

FIG. 9 shows an example of multiple teams partaking in a dynamic team representation, in accordance with the method of the present invention;

FIG. 10 shows a proposed structure, in which the method of the present invention has been employed;

FIG. 11 shows a flow diagram illustrating the direct challenge implementation of a method in accordance with the present invention;

FIG. 12 shows a flow diagram illustrating the open challenge implementation of a method in accordance with the present invention;

FIG. 13 shows an example of a players account when challenging and accepting a challenge in accordance with the present invention;

FIG. 14 shows an example where flexible standard offerings are provided to players;

FIG. 15 shows a PSF on which a ranking loss in accordance with the present invention is implemented;

FIG. 16 shows an example of a typical game fee or pool split, in accordance with the present invention;

FIG. 17 shows an example of a calculation of a national event PSF and a benchmark average, in accordance with the present invention;

FIG. 18 shows the composition of a pool with a jackpot portion and a guaranteed daily payout portion, in accordance with the present invention;

FIG. 19 shows an example of a seasonal daily club event scored in accordance with the present invention;

FIG. 20 shows the ranking of winners, in accordance with the present invention;

FIG. 21 shows the ranking of individual player events, in accordance with the present invention;

FIG. 22 shows various method of calculating the PSF, in accordance with the present invention;

FIG. 23 shows an example of an event, which assumes a maximum loss, calculated in accordance with the present invention;

FIG. 24 shows a skins contest where teams compete against each other and in which the scoring is calculated in accordance with the present invention;

FIG. 25 shows how dead heats are treated in the present invention;

FIG. 26 shows the calculation of a leading score and the allocation of prize money, in accordance with the present invention;

FIG. 27 shows an example of the calculation of club fees, in accordance with the present invention

FIG. 28 shows a player skill factor rating matrix, used to split pools in divisions;

FIG. 29 shows an example of Team skins challenge options;

FIG. 30.1 shows an example of basic game fixed offerings;

FIG. 30.2 shows an example of basic game flexible offerings;

FIG. 31 shows an example of a bonus pool;

FIG. 32.1 shows an example of an advanced runner/manages runner pool with basic selections;

FIG. 32.2 shows an example of a live in-game practical access example;

FIG. 33 shows how a player earns bonus selection rewards;

FIG. 34 shows an example of retrospective skills based player rewards;

FIG. 35 shows an example of odds differential based gross player private challenges; and

FIG. 36 shows a cost comparison between a pari-mutual game cost and the cost of the present game.

### EMBODIMENT OF THE INVENTION

The design objective behind this invention is the creation of a completely original structure and a unique format that will provide the racing industry with an effective marketing tool to promote the sport of racing by offering unique player participation in either a pure sports format or sports gaming or sports wagering format.

The invention covers the following aspects of which some are merely mentioned for background purposes and others covered in detail:
A newly created comprehensive competitive structure
Provision for a host body or events co-ordinator which in one or some embodiments could also be a betting operator
An original and ultra-competitive format to ensure close and exciting competition
A brand new standardised game format to ensure that all players will be able to compete equally with only skill and ability differentiating players
An original player ranking method that includes unique components in an ability rating and ability allowance (PSF) that could be used in some or all applications
A first ever formalised player private challenge structure and system that will uniquely be managed by the event coordinator/administrator or betting operator
A unique playing feature called Dynamic Team Representation (DTR) that allows every individual player the opportunity to simultaneously represent their teams or clubs at any level of competitive play without nomination or selection for a limited team
Provision for merit selection and ultimately colours in some embodiments

One of the primary objectives of this invention is to provide the racing industry with a unique new competitive format to attract fresh interest in racing. A further important objective is to encourage non-players to undertake and complete the unavoidable skills learning curve, as well as to aid in the shortening of this curve, in order for them to become successful long term participants. This area has long been the racing industry's greatest challenge and one that has yielded very little success through traditional marketing methods.

### Defining Equine x as a Unique New Racing Sport (Claim)

To define and present an activity as a sport a number of important aspects needs to be addressed, which includes establishing a skills based level playing field through a standardised and competitive game format, a comprehensive competition structure, appropriate rules and regulations to govern the game or sport with a long term goal of establishing a credible sporting code, which will ultimately support the granting of sports colours to players that excel.

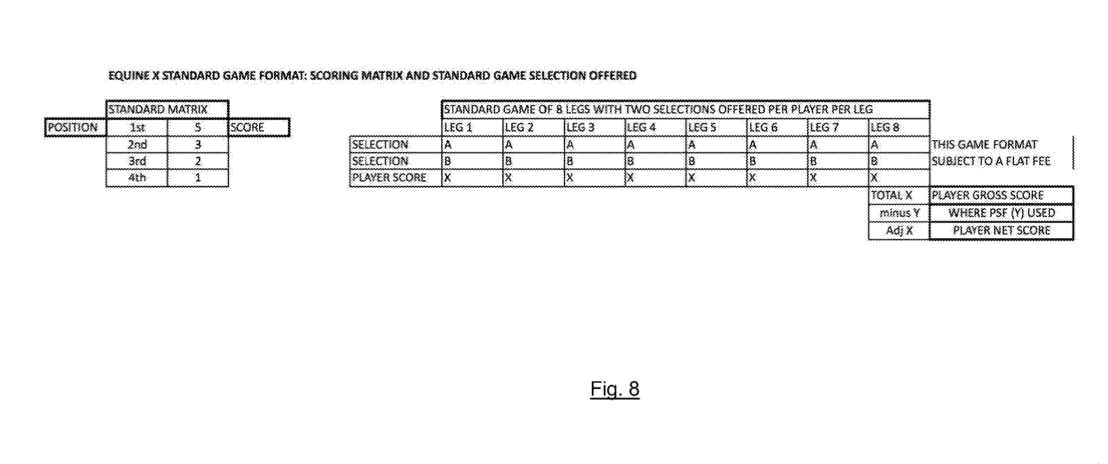

### A Standardised Game Format and Structure (FIG. 8)

This is undoubtedly one of the most critical aspects of creating a competitive sport or sports gaming environment as it is essential and desirable that players should compete primarily on ability or skill alone, which necessitates creating competition under identical or near identical conditions as far as possible.

Competing under identical conditions is almost impossible to achieve in most sports given the many normal variables such as weather conditions, equipment and venue differences in some instances, differences in physical attributes of players, differences in their financial means, or the impact of access to large sponsorships providing many advantages to teams and individuals.

This invention uses a unique format, structures and identical events, as well as a newly designed customisable standard game format, and makes provision for an affordable flat game fee (claim) to provide players with the most fair and competitive environment to participate in.

One of the most important elements is the number of selections that a player will be allowed to make in each leg of a standard game, as one of the critical objectives is to develop each player's level of skill through competitive game play and supportive design. Generally, in contest style games, players are only allowed a single selection per leg/race but with newcomers and novices this could be counterproductive, as it could quite easily promote the selection of only the favourite in each leg, as statistics show that this would normally produce the most consistent outcome. The objective is to aid each player in developing their general level of skill as well as the finer and necessary art of selecting runners through form and ability analysis capable of beating the favourite, which suggests that offering more than a single selection per leg of the game or some legs of the game, will be much more effective in promoting the desired objective. Providing multiple selections will also lead to more competitive events, thus providing a greater degree of entertainment and enjoyment to players.

Achieving the optimal balance is paramount though as too many selections offered will reduce the advantage and value of skill and too few offered will not be supportive of creating the ideal learning environment for skills development. By offering more than a single selection per leg players will have the opportunity of selecting the favourite as well as any number of selections provided as alternatives that could beat the favourite, which is what racing skill is really about.

To create the recommended standard game format, the following criteria was considered for optimal impact, playability, fairness and maximum enjoyment:
The length of an individual game, in this instance the number of legs (races)
The number of games required to form an extended event or set of events
The number of players that can participate at any one time with the objective of having a no player limit game which is something of a sporting rarity
The number of selections (runners) provided for players to choose in a standard game
The number of combinations allowed per player
The degree of player differentiation needed to determine winners
The use of a uniform ranking and scoring method—universal points system
Provision for an alternative index based scoring system that recognises both positional reward and the skill and relative difficulty of finding longer priced finishers
The use of a standard player skill factor (PSF) methodology that could be introduced in some or all embodiments of the game
Decisions around the cost of a game and the further sub-allocation of this and other competition fees with reference to extended or additional events
The number of recognised runner finishing positions and player reward positions
A uniform reward or recognition methodology
Determine suitable player registration criteria
Dynamic Team Representation—each player can uniquely contribute as a team member to overall events without the need to be specifically selected to represent their club/team (claim)
Identical rules at club/team, regional, national, international or any other level
Uniformity around the rules for merit based selection of players for prestige events where colours could be awarded for sanctioned events
Players can compete simultaneously, both individually and jointly in a team or club event and multiple other events utilising only a single entry prediction.

Although many of these aspects falls outside of the scope of a patent application it is mentioned here to provide additional background and to provide the patent office with greater clarity and understanding in terms of the unique nature of this invention.

### The Standard Game Created for Equine x

Although the design caters for many possible game variations, the proposed standard game format created for Equine X, takes into consideration all the important factors that make for a competitive and fair environment further aimed at promoting the education of players and an offering as a significant potential future sport.

The importance of creating an educational element to involvement should not be underestimated, and as such this invention aims to teach people about racing and how to access and handicap races effectively, all of which will happen in an enjoyable competitive as well as social environment. Equine X will assist players to be more competitive and successful in any of the designed applications and racing formats that form a part of this invention, but also enable them to have a more profitable and enjoyable future involvement, if they so wish, in an existing traditional racing wagering environment.

Whilst players wagering on racing derives a benefit from skill and ability more affluent players mostly have a distinct advantage as they can afford to bet on multiple outcomes, Equine X has been designed to provide an absolute test of skill as all players will compete under exactly the same conditions in each and every event.

This invention is additionally about how this translates into supporting players to become effective and successful racing form analysts and participants.

Learning becomes much easier and quicker when it takes place in an environment that is enjoyable and entertaining which is what participation in this newly invented format will facilitate. Creating an interest by offering participation in an easily accessible and socially competitive environment will be very effective in promoting a long term and regular racing interest and a better understanding of racing in general.

Equine X is a unique sporting challenge that will make it possible for young and old of any gender, including anyone with physical disabilities or difficulties to compete against each other equally, based on mental skill and ability alone.

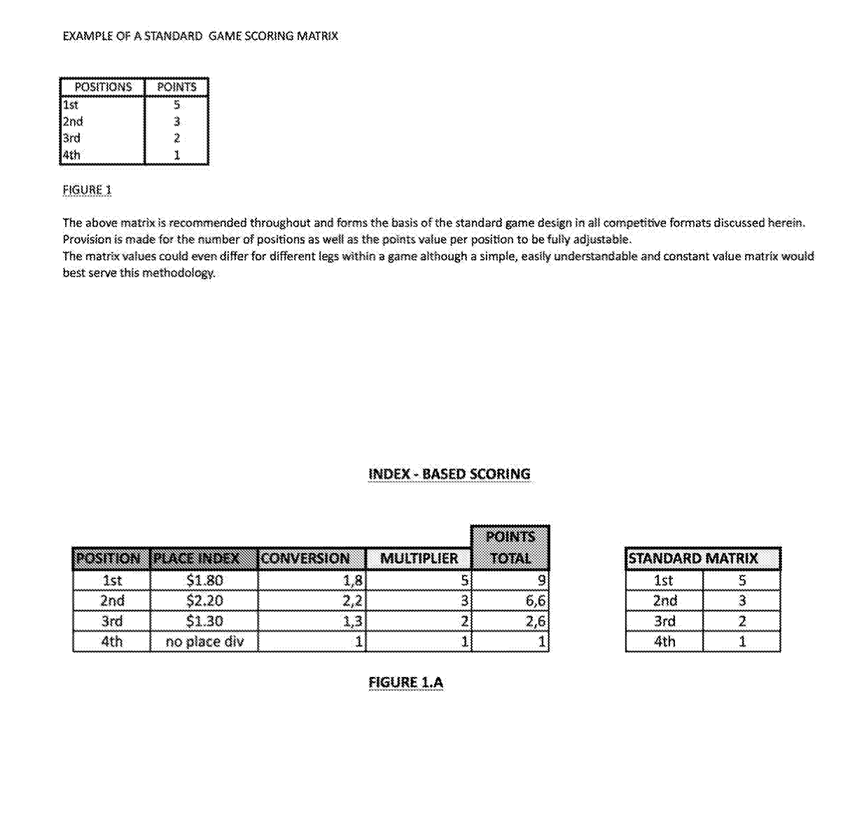

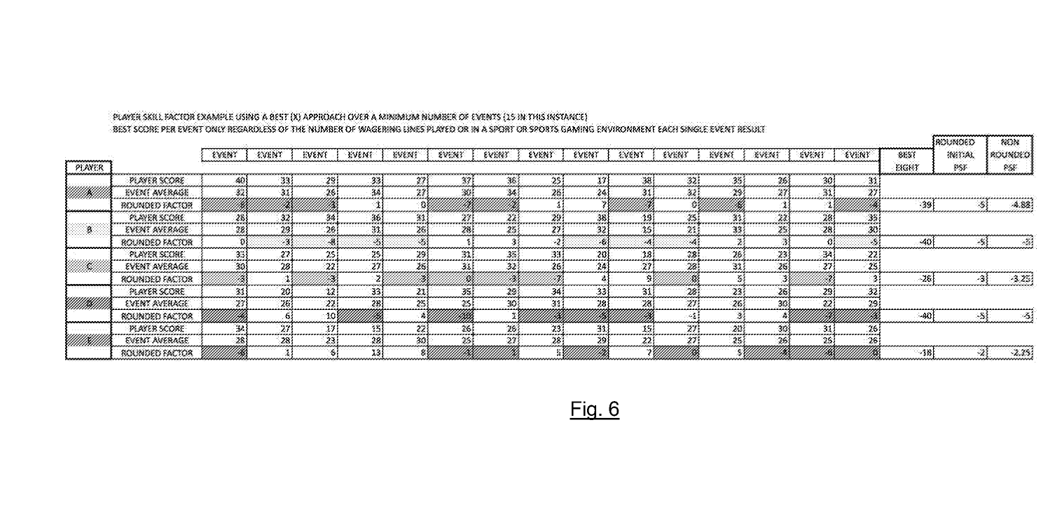

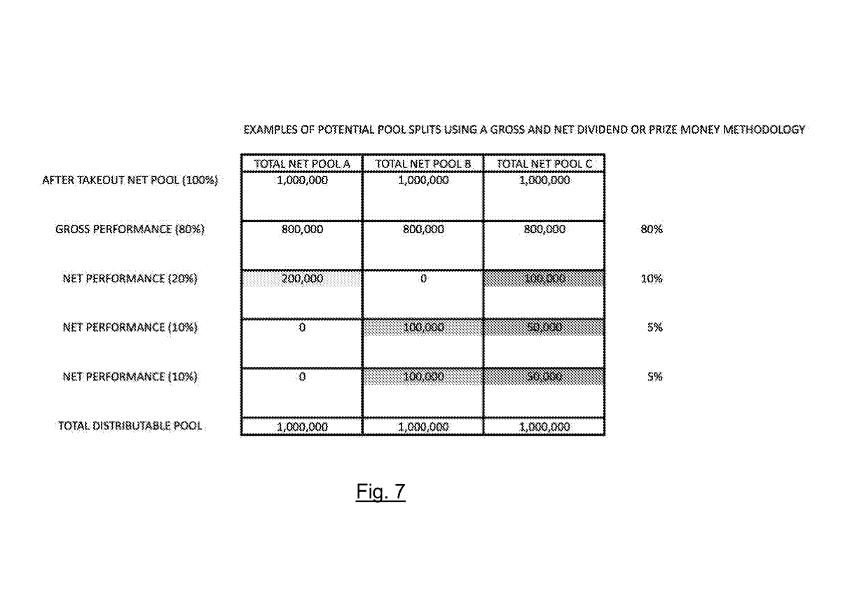

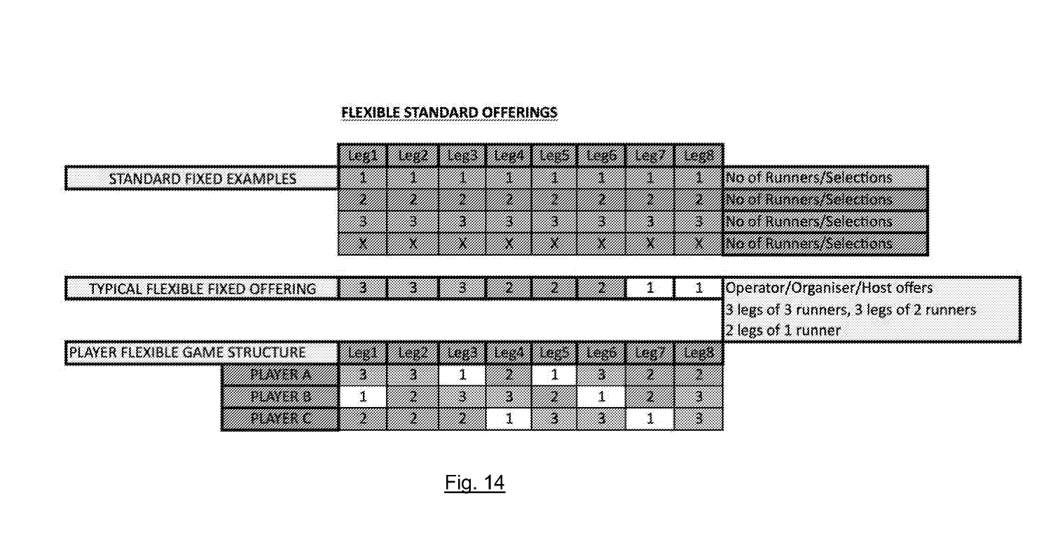

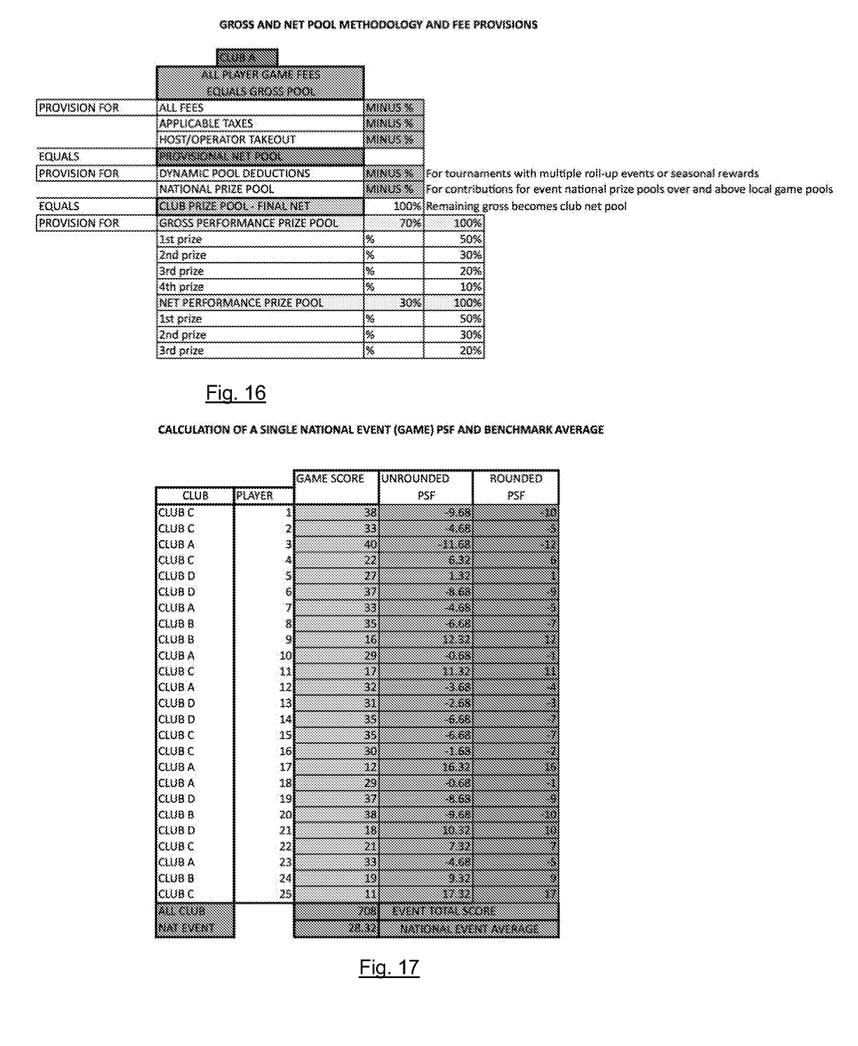

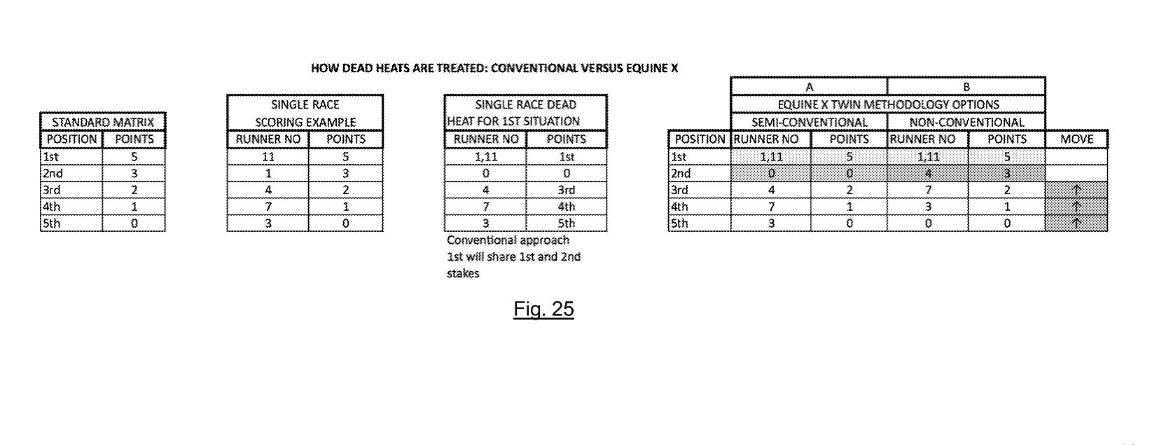

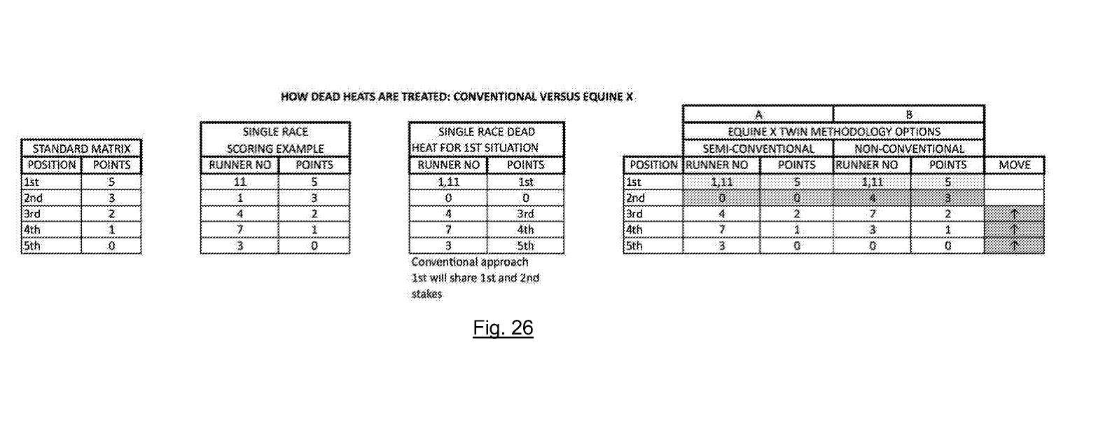

The proposed standard game format and structure: (FIG. 8)
8 legs (races) to a game would be optimal (but caters for any number)
Races can be selected by the event organiser from single or multiple race meetings, locally or elsewhere and even over more than a single day
4 recognised positions in every leg (race) (provision for more or fewer positions or a varying number of positions)
A standard scoring matrix with values 1st=5 points, 2nd=3 points, 3rd=2 points, 4th=1 point (the matrix methodology caters for any number of positions and could have any pre-selected set values with further provision for floating values per game leg) (FIG. 1)
Alternative index-based scoring method where the standard matrix will be used as a multiplier and where the actual place dividends declared will serve as a variable index (FIG. 1.A). The index dividend value, converted to a number, times the multiplier will provide a score per leg. It is advised that this method be considered in a format where players are restricted to a single selection per leg (as a lower finishing runner could outscore a higher finishing runner with this methodology) or alternatively in a game format where the highest achieved score per leg will be used, regardless of the positional finish of the selected runner or runners. Whichever method used should be clearly stipulated in the game rules. Where no place dividend is available or declared only the matrix value (multiplier) will apply. (FIG. 1.A) This methodology will reward the ability to select highly placed runners and offer further and at times significant additional reward if the runner is a longer priced contestant. With the matrix positively tiered per position, the higher the selected finisher, the bigger the multiplier effect will be!
The matrix values should ideally be kept constant for the duration of a complete season, preferably remaining constant for an indefinite or prolonged period to establish familiarity with the concept and scoring method but provision is made for changes if or where required
The length of a season, start and finish to be determined by the licensed controlling body, normally within a calendar year but could also be over two calendar years or any pre-determined period
Only one game per player per event, as this is to be offered as a sports game or sport
Players have to register with a club or team, depending on the structure, to be able to play, only one club/team membership per player, multiple memberships not allowed
One standard game format offered per player, single or (X) runner selections per leg (caters for any pre-determined number of runner selections per leg to be decided by the licensed host/event coordinator or betting operator)
Provision for a flexible standard offering that will allow players the opportunity to structure their game as they prefer within a set of predetermined parameters. For example in an eight leg game the offered combination could be 3 legs with 3 runners, 4 legs with 2 runners and 1 leg with one runner which could be expressed as 3×3×3×2×2×2×2×1 as far as the basic structure is concerned. A player could thus choose 2×3×1×2×3×3×3×2 or any combination of the runner offering as long as the overall structure is retained, which in this embodiment means that the operator provides a predetermined overall set structure but the player is offered a flexible sequence of legs. (FIG. 14)
A standard affordable flat fee per game, to be determined by the licensed operator/administrator/organiser annually but caters for any periodic or ad hoc adjustment or special game fees
Makes provision for team and individual events and tournaments/competitions
Makes provision for prize money and/or prizes for players and dividends in a wagering application
The player or team reward structure makes provision for a winner and any number of runner-up positions (proposed 1st, 2nd, 3rd and 4th)
The reward and award structure makes provision for gross and net performance (PSF) recognition and reward (FIG. 7)
A certain number of pre-defined annual competitions are already catered for in the design but makes extensive provision for tournament and event expansion
Ad hoc events and tournaments/competitions also catered for
Players will be allocated an official and usable skill factor (PSF) calculated after (x) number of events has been entered into (FIG. 6)
Proposed percentage prize money split of net pool (after take out and fees) for gross performance reward, 1st=40%, 2nd=30%, 3rd=20%, 4th=10%, caters for any number of reward positions and percentages or fixed amounts (FIG. 16)
Proposed percentage prize money split of net pool (after take out and fees) for net performance reward, 1st=50%, 2nd=30%, 3rd=20%, caters for any number of reward positions and percentages or fixed amounts (FIG. 16)
The proposed gross performance pool will be 70% of daily overall net pool, ability allowance net performance pool 30% of daily overall net pool, caters for any percentage or fixed amount split but advised that net performance should usually have a lesser weighting (FIG. 16), but could also have an equal or higher weighting
Final net prize pool will be determined after deduction of take out, costs and fees and any extra funding of dynamic longer term or special events (FIG. 16)
The design caters for extra pools for members exclusively which makes provision for separate entry fees or wagering stakes in a wagering application over and above normal daily game fees (optional involvement for members)
Annual membership fees are proposed and provided for to be determined by the operator/administrator/organiser in one embodiment as a club offering
In the event of tied games provision are made for sharing of prize money/prizes and/or allocation after ranking separations or adjustments based on a pre-determined count out methodology.
Provision is also made for pari-mutuel style rewards calculation where winners receive prize money based on the net pool or net pool divisions divided by the total number of winners per event, position or division
All local jurisdiction or universal racing (totalisator or betting operator) rules to be applied throughout to determine race results and winners unless otherwise specified so as to facilitate in the racing education process of players and to ensure an unbiased and regulated outcome, void from potential manipulation
Game specific rules could also be introduced and is catered for extensively in this design
Dead heat runners will all qualify for exact positional points distribution, no sharing and splitting of points proposed, but possible, for example two runners dead heat for 1st, both runners earn 5 points, the actual other placed runners to earn the normal matrix points for the remaining positions which means that there could be more than the proposed 1st, 2nd, 3rd and 4th (4) runners earning points in these situations, provision for two proposed methods (FIG. 25)
With the above dead heat methodology in place only a single highest placed selection will qualify per player for scoring purposes in a sports game or sport format, unless a multiple selection aggregate scoring method is utilised in which instance all selections dead heating will earn equal points throughout.

### Prize Money, Prize and Dividend Considerations

With Equine X catering for prize money, prizes and dividends provision is made for positional reward as well as pari-mutuel style shared dividends. Shared dividends are straight forward with the final dividend determined by dividing the allocated pool by the number of winning players. This differs from traditional pari-mutuel dividends where every correct betting line qualifies for a pay-out, whereas this game does not recognise individual betting lines as only a single best performance per game category (including gross and/or net) per player qualifies for reward.

When positional rewards are in play it becomes necessary to differentiate players further in order to reduce shared rewards which would often not be practical or desirable where prizes are offered or where too many players will potentially occupy a reward position. To cater for this, provision is made for count outs to effectively reduce those in contention to single candidates per position. A pre-determined count out structure for Equine X games will be introduced to have a standardised format to deal with these situations.

A count out format should always have a recognised starting point and a standard sequence to work through to narrow down the candidates to a single positional winner. For example: on an uneven game date the first differentiator could be to total tied players uneven leg totals, even on even dates. Thereafter any other differentiating possibility for instance, first 5 legs, last 5 legs, first and last two legs, first three legs and last two legs and so forth until a single winner can be identified.

The PSF could also be used in tied positions with the position being allocated to either the highest or lowest rated player. If the entire sequence has been exhausted and players are still tied it could come down to a draw to determine the winner, but provision is made for tied winners to be declared in the interest of fairness.

### Summary of Game Options Provided for in an Equine X Game or Contest (Host/Operator/Organiser/Controlling Body to Decide)

Straight line option where a player is allowed to choose only a single runner/contestant per leg of the game
Option where a player is allowed to choose (X) number of equal runner/contestant selections offered per leg (could be any number)
Option where a player is offered a set but flexible structure with a specified number of selections in a specified number of legs
Fixed (X) number structure with added flexible bonus (X) runner allocation
Fixed (X) number structure with built in (predetermined) bonus (X) allocation
(X) number total runner pool provided with players having complete control over the allocation per leg of the game either on a one directional draw down basis or multi-directional managed pool basis

### In-Game Positional and Approximate Prize Money or Dividend Considerations

Whether Equine X is offered as a sport, sports game or wager, it will require in-game positional, and depending on the application, predicted prize money or dividend updates.

This is a very important aspect as players in a competitive or wagering environment require up to date information on their progress, position and approximate dividends or prize money in an event, game or wager. It positively adds to the excitement of involvement, complements the atmosphere and appeals to the inherent competitive nature of most people.

In pari-mutuel multi-leg pool betting an elimination-based methodology is used in all products, which consider the number of possible combinations over a series of races from bets that have been struck and these combinations or betting lines are reduced as the game progresses, with only potentially correct combinations advancing. This enables a betting operator to provide an updated approximate dividend after completion of every leg that creates a sense of anticipation amongst players that have not been eliminated along the way.

With Equine X incorporating an original non-elimination methodology it is necessary to consider the most appropriate way to present prize money or dividend updates, as well as adding the new element of player positional information.

A few original alternatives have been considered to best support the methodology (matrix scoring player ranking) employed in Equine X.

Although a pari-mutuel approach to combinations could be utilised, the non-elimination approach of this invention will be better suited by the following approaches:

Three practical methods have been considered for this purpose with simultaneous use in some instances:

### 1. Leading Score Approach—Basic Method (FIG. 26)

With this method the leading score is merely updated and published after each leg of an event which will indicate to players where they are positioned in relation to the lead. For sport or sports gaming events this approach will be simple but highly effective.

In as far as dividends and/or prize money is concerned the following two methods are catered for in this design:

### 2. Lead Player Provisional Dividend (FIG. 26)

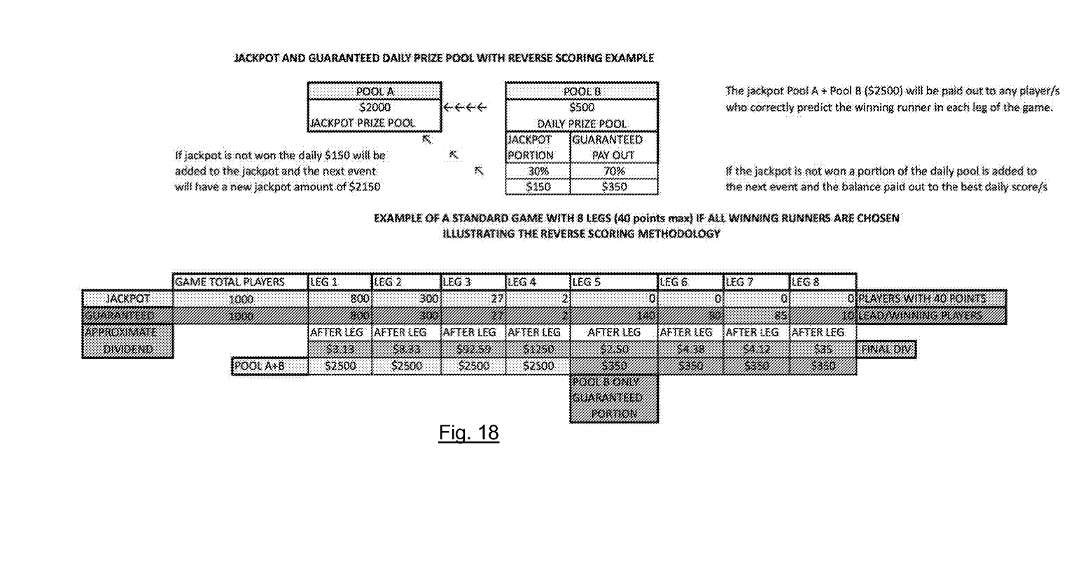

As no player-elimination takes place in Equine X with an original ranking order approach being used, the number of leading players after each leg should be used as the divisor into the available prize pool to calculate an approximate dividend. With the players in contention able to grow or decline after any leg, a unique feature in wagering terms (claim) (FIG. 18), this method will be most effective and have universal use.

The number of combinations remaining can thus be completely ignored with the focus entirely on the total players leading at different intervals of the game. In a sport or sport gaming mode where each player is only allowed a single game entry, with only one highest score qualifying in each leg, including dead heat situations, no multiple winning combinations will exist, which will make this method perfectly suited to the game.

### 3. Reverse Scoring (FIG. 18)

Reverse scoring is an alternative method that can be used to calculate progressive dividends in a wagering game.

Rather than using the number of players leading on a maximum score after each leg of the game, this method assumes that all players can score a certain maximum (for example 40) at the start of the game and then calculates backwards using the remaining players that can still score maximum after each interval in the game.

Once the last leg is reached the selections of all the players still able to score full marks are sorted per the runners in the race and each becomes the divisor to calculate the final dividend, with due consideration to scratched runners having to be added to the tote favourite which will affect dividend if this runner should win.

This method could be useful in pools where both a jackpot and guaranteed dividend is in place with the jackpot considering the total prize pool and dividends calculated with reverse scoring and the guaranteed pool using the lead score method to determine the progressive dividend.

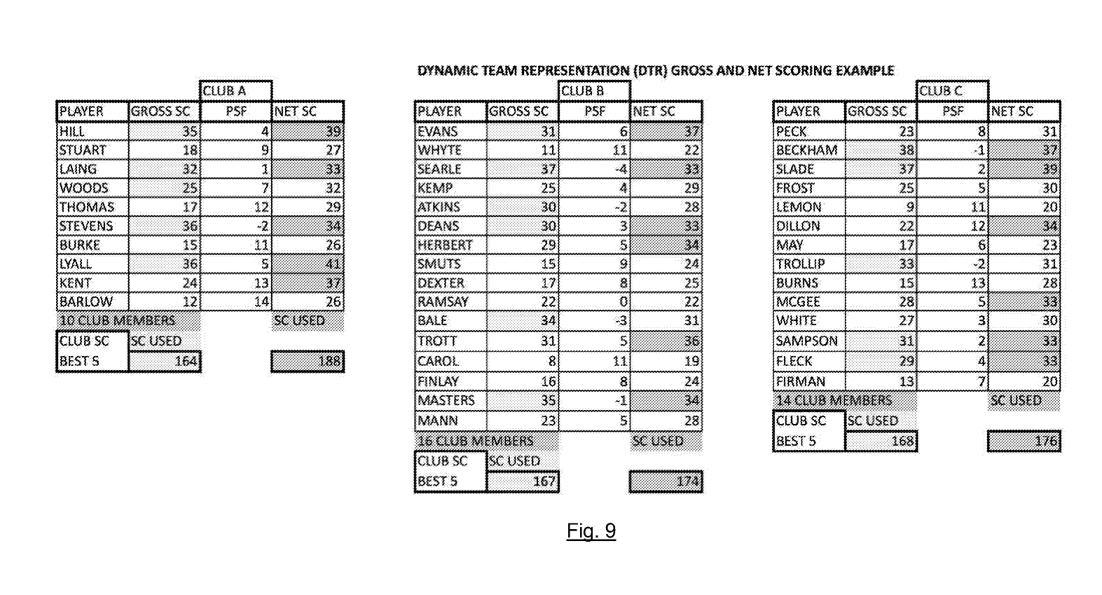

### Dynamic Team Representation (Claim) (FIG. 9)

Dynamic team representation (DTR) is a unique and exciting feature of this invention that will ensure that all players have the rare opportunity to simultaneously be in contention to contribute towards a team or clubs performance without the need to meet any advanced team selection criteria. It is a unique and most inclusive form of team representation designed to generate essential team spirit amongst large numbers of participants that would normally have had little or no opportunity to be part of their representative club/team's quest for top honours in a normal sport environment.

(DTR) will make it possible for infinite or large numbers of contestants to represent their club, team, geographical region, country or other grouping without the need or the hurdle to be pre-selected for a limited representative team. This will give every player the much sought after opportunity to contribute in a fully competitive environment and with due recognition and acknowledgement of those players whose performances qualify for utilisation in the final results. It will also make it possible for teams with large differences in the number of players to compete equitably without the need for game-limiting restrictions or player number limits.

Although players will not be eligible for sports team colours under (DTR) it is a format that will allow individual players or casually formed teams recognition for their contribution towards their side's performance. It is designed to provide individual acknowledgement for outstanding achievements by formally recognising the contributing player/s or team's role in the official club/team's overall results. (FIG. 9)

It is provided for that after each event the club and contributing individual statistics could be formally published to provide constant acknowledgement and recognition of performance.

Dynamic Team Representation is a specific claim that also relates to the ability of each registered club member or player to uniquely be both a team member and an opponent for other and local club members during competitive and representative events. This claim relates to providing every participating club or team member the opportunity of posting a score for their team/club which is a unique feature in sporting terms. There is no sport or game where every player, regardless of teams or clubs having different numbers of members or participants, including very large differences, can simultaneously take part competitively for the benefit of their team or club, without the need for pre-qualifying or pre-selection of an even numbered and limited representative team.

It is proposed that the best (x) scores of all team or club participants will be utilised in a number of annual seasonal competitions and other ad hoc or regular tournaments. The exact (X) will be determined when the sport structure is finalised with due consideration of the overall number of players per club or team with provision for annual and periodic, as well as ad hoc adjustments and is further highlighted in another part of this application. (FIG. 9)

Team events could be decided using the created best (X) methodology either as a comparative aggregate score or an average score with extensive provision for gross and net performance (ability allowance—PSF) measures and events. Either method will yield the same overall result or outcome.

(DTR) will make involvement far more rewarding and meaningful for all players and will introduce a very exciting element to overall participation. It will also create the foundation for a new set of qualifying criteria for individual recognition that will culminate in at least one prestigious planned annual event.

This format caters for the recognition of players that have contributed the most towards their club/team performance throughout the season by allowing them exclusive entry into a prestigious separate short event (proposed 4 games) tournament for a select group of players that have qualified through outstanding seasonal performances.

In short, the number of players who have contributed the most amount of times towards the team score throughout the official season will qualify for a proposed individual contest where an overall winner and (x) runners up will be crowned. The number of contestants that will qualify for this proposed event will not be limited to a fixed number but could vary from year to year and will be determined by criteria that could include the top (x) contributors from each club, region or team or other qualifying criteria. The (x) could differ because all players with a similar amount of contributing scores will receive recognition even if multiple players have equally contributed to a qualifying number of representative scores.

DTR could be applied in a gross or net scoring environment, in any or all team based events, and will add another dimension to team involvement by providing many more players the opportunity of contributing to the team's results and overall performance and possible success.

### The Introduction of a Unique Player Skill Factor (PSF)

A specific objective of this invention is to create a competitive sport environment for all players to grow in from a skills perspective, and to have a benchmark for players to measure their personal level of skill and ability and changes in this ability.

It is a further objective to create a unique tool that will allow players of different skill and ability to compete more closely and to introduce this for potential use in a sports game, sport or wagering environment as well as any combination of these. (FIG. 4)

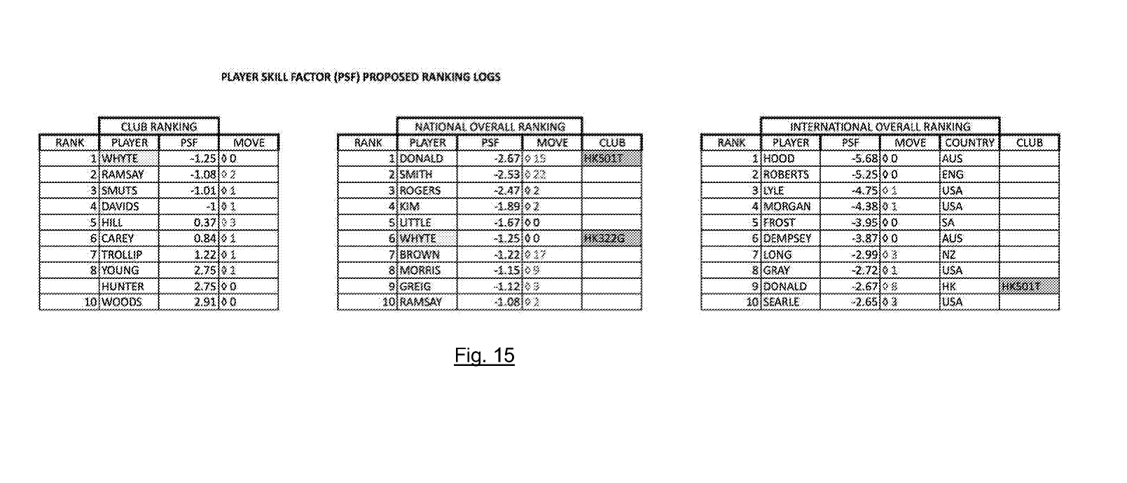

This invention introduces a unique (PSF) that will have very specific value and usefulness in the establishment and promotion of racing as a competitive sport or sports game as well as in wagering applications. The (PSF) will be a measure of relative ability and provide each player with an ability rating, and create the opportunity of using this rating as an ability allowance in all or selected competitive game play and or wagering pools as well as for player ranking purposes. (FIG. 15)

The (PSF) can be calculated in any number of ways but in the most practical and useful embodiment will be determined and applied as set out in further paragraphs of this patent application, which follows hereafter.

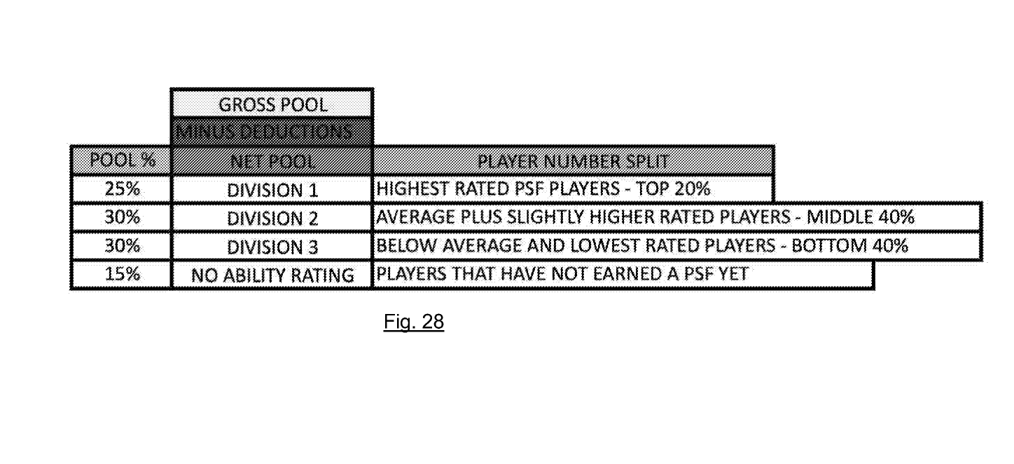

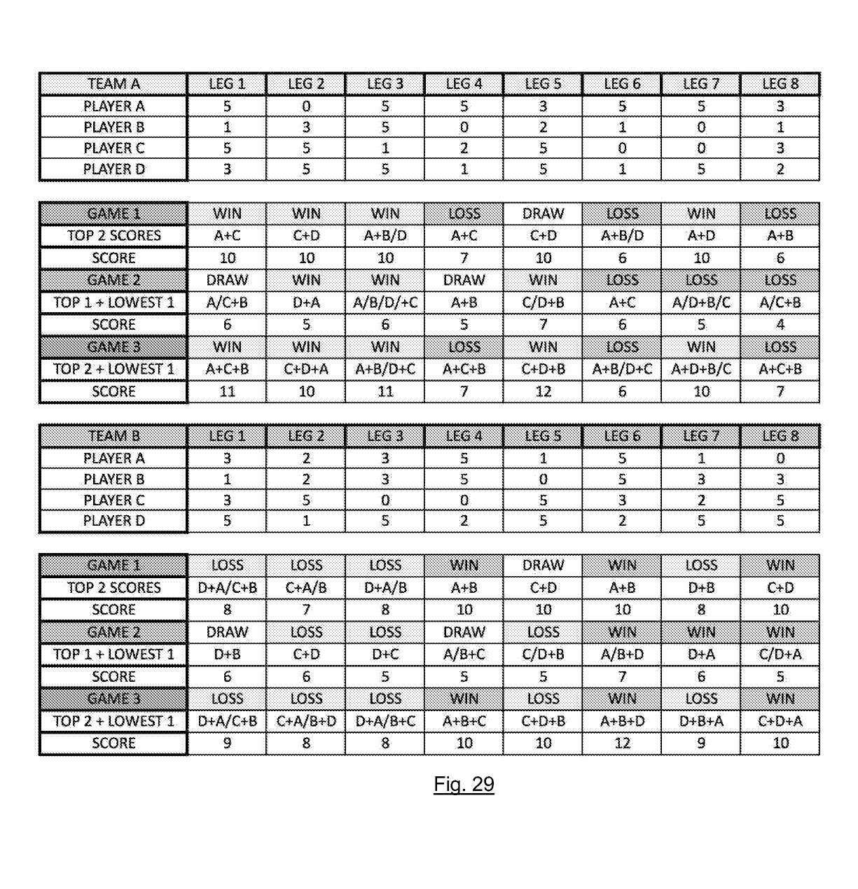

A player skill factor will serve as:
A measure of a player's individual level of skill and ability at a given point in time
A measure of a player's relative ability when compared to other players
A tool to measure personal improvements or changes in skill
An enhancer to promote closer competition in some proposed competitive sport and game formats and also for proposed use in wagering events and pools
An aid to specifically new and novice players to enable them to be more competitive from an earlier stage of participation
A constant aid to players of lesser ability to be more competitive which will add to individual enjoyment and participation
A tool to differentiate and rank players for the selection of players for limited representation in some proposed sporting or gaming events (FIG. 15)
A method to provide a level of stability to a player's performance through regular adjustments of the PSF
A tool that can be used in numerous ways in competition count out situations
A ranking method to recognise individual ability and prowess at different levels of competitive game play (club, regional, national, international or other) (FIG. 15)
A means to divide players into different divisions in competitive game play as part of the objective to make players of different ability more competitive (FIG. 28)

### Calculation of the PSF—Considerations

Racing is unique in that no two events (the outcome of a single race or a series of races) will produce the same results, even when repeated under similar or exactly the same circumstances, and it is therefore challenging to establish a benchmark that will accurately express the level of difficulty of any concluded event.

To ensure a usable and accurate PSF a reliable benchmark must first be established that will produce consistent and credible results. In the proposed standard sport game format, points are scored according to a set matrix and the finishing position of runners in a race. Where an event or game consists of a number of races, points will be earned in each race and the average of the total game points scored by all players will provide a reliable benchmark for calculation purposes, especially since the PSF is needed and will be valuable in determining whether a player has average, below or above average ability and skill. The PSF will be introduced to compensate for this variance in ability amongst players so that all participants can be more competitive in relation to their peers in some or all of the competitive events and certain wagers that are being provided for. (FIG. 17)

Using a current game event average each time will provide a suitable difficulty adjustment, as this average will clearly reflect to what degree the outcome of an event was challenging, standard or relatively easy (claim). (FIG. 6)

This average will immediately provide a useful event benchmark that will benefit substantially from further growth in the number of players, as a bigger pool of players will lead to an even more accurately defined average. (FIG. 6)

In events where many fancied runners do well the average score for the event will mostly be much higher than in events where un-fancied or lesser fancied runners dominate the outcome of the subseries of events making up the offered contest. The more skilled player is expected to do better than the unskilled player under these circumstances and this will be highlighted when measuring individual performances against the event average. As such it will be a very useful measure to determine variations in skill and ability. Although luck can play some part in the selection process the value of skill would be most apparent in the variation in the degree of consistency in performance between skilled and unskilled or lesser skilled players, especially when measured over an extended number of events.

With club/team members in some embodiments simultaneously taking part in national events both for their club/team and as opponents to local and national club/team members the national event average will be used for the calculation of individual player PSF's at all levels (claim). (FIG. 17)

Provision is however made to use only individual club, regional or limited specified averages for PSF calculation purposes under certain circumstances.

Using an event average has the added advantage that a PSF could be calculated and used for shorter or longer than standard length events or mixed length events, or as happens on occasion because of bad weather, only partially completed events.

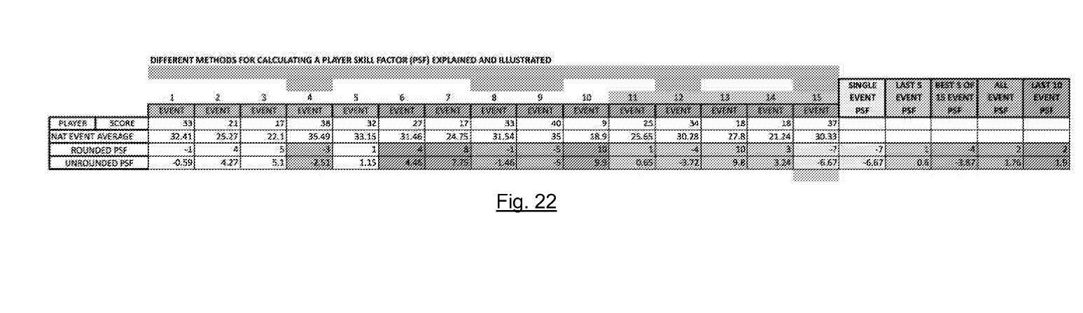

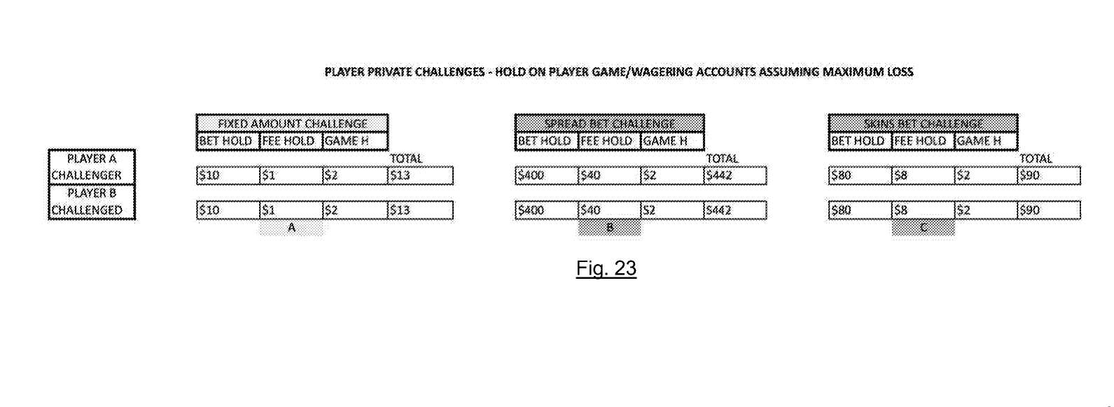

It is provided for that a PSF could be calculated for or after just a single event but for a reliable outcome several events should be totalled and averaged which will ensure a more accurate reflection of a player's relative ability. (FIG. 6) (FIG. 22)

The exact number of events (N) to be used could be any number but for the greatest degree of accuracy and relevance it would be best to use a fairly large number of event outcomes from a recent time frame to ensure that current ability is adequately exposed and reflected. (FIG. 6) (FIG. 22)

A PSF could be calculated using all scores achieved across multiple concurrent offerings or be limited to only competitive sports or sports gaming events or include wagering events where offered exclusively to club members or even where a PSF is provided for and used in a pure wagering environment.

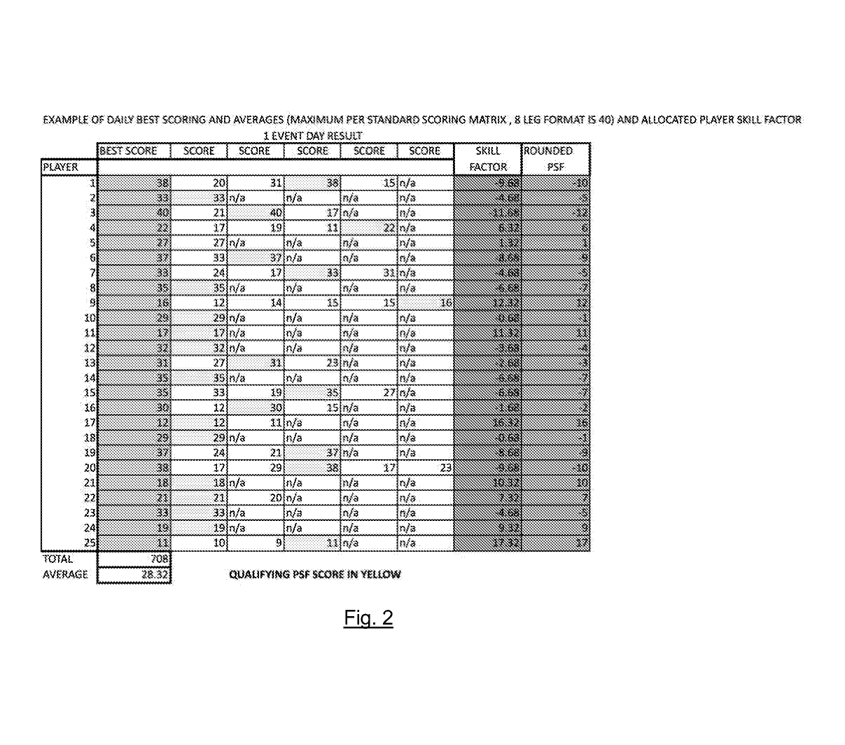

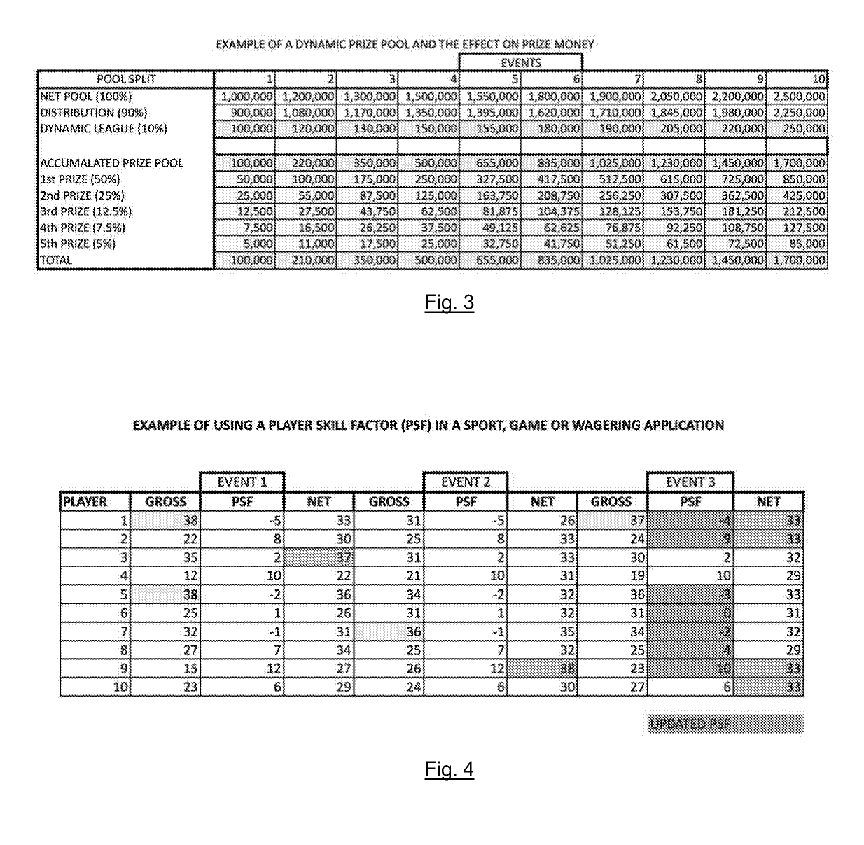

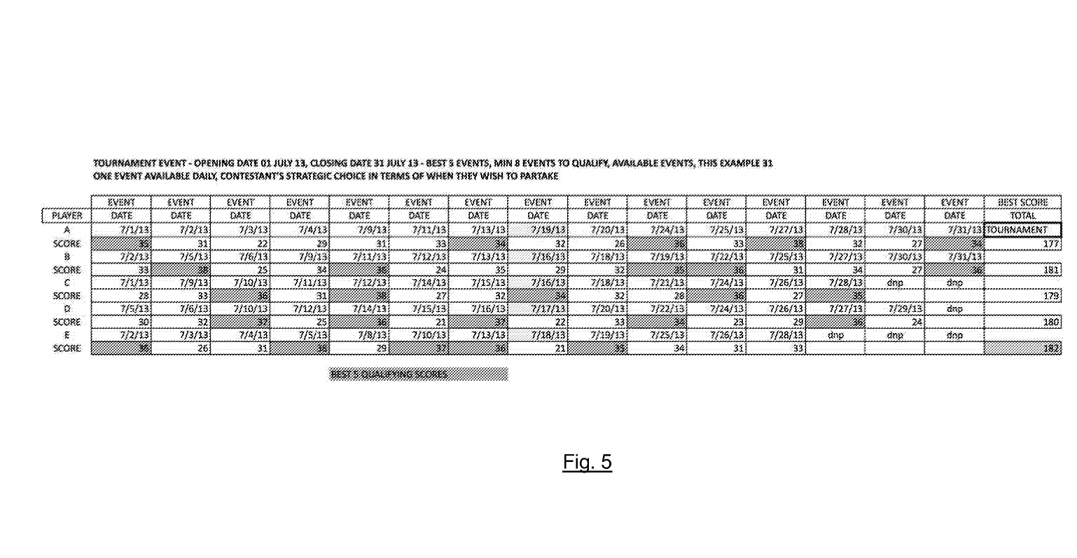

In a pure wagering environment where multiple games can be played by an individual, also known as straight line wagers or permutations/combinations, only the best result for the event should be used for PSF calculation purposes. The invention does however make provision for a PSF to be calculated on every line, game or permutation played in the case of multiple entries but this method is not recommended as it opens up possibilities for manipulation of results, especially where large sums of money are concerned. (FIG. 2)

It is recommended (not limited) that rewards utilising a PSF should be used in a limited wagering capacity, for example a smaller percentage of the pool allocated for this purpose as a consolation dividend. It is foreseen that a PSF could have a more comprehensive and widespread use in a competitive sport or sports gaming environment. (FIG. 7)

All calculations of the PSF will be done at all times on gross performances only. Even though net performances could be used it will lead to distorted results and is thus not recommended or perceived to be useful.

The PSF could be expressed and used as a rounded figure, or for much greater player differentiation any number of decimal places could also be used and are provided for. (FIG. 6) (FIG. 2)

Although this methodology caters for widespread use in any application the intention is to use it in a limited number of and pre-determined types of events, and also in a limited wagering capacity.

An important added consideration is the frequency of calculation which could be after every event or periodically at pre-determined intervals or after a given number (N) of events.

Provision is also made for ad hoc re-calculations at any point in time where circumstances could require or dictate an update. (FIG. 4)

The intention of this invention (Equine X) is to always recognise and reward outright performance (gross) but to make extensive provision for additional reward and recognition by means of a PSF aided net result in all or a number of events or wagers to make it more rewarding for players of all abilities, so as to promote growing and continued large scale racing participation and interest. A PSF could also be of great value in specifically a sport or sports gaming application by making it possible for players of different ability to compete in PSF tiered or graded events.

The invention of a PSF creates a useful further opportunity for the formation of divisional pools with players able to progress or in certain instances regress to different pool classes in which they will partake against players of similar ability, thus providing them with a greater opportunity to be competitive. (FIG. 28)

Any number of different divisions is catered for and is to be determined by the licenced organiser/host/operator.

Pool progression or occupying a higher division could be a further source of bragging rights and a means for players to measure relevant changes in skill and would act as a benchmark and an incentive to further improve individual skill and ability. Unranked players could also be specifically catered for with one of the proposed pool divisions specifically allocated for this purpose with players progressing from this division as soon as they have earned a PSF in line with the utilised rating structure. (FIG. 28)

### PSF Calculation Consideration Criteria—Summary

Equine X makes provision for all players to take part locally, nationally or even internationally in single universal events with multiple sub-events catered for from the same set of results.

Under most circumstances players will take part in periodic (proposed weekly, but could be any interval) events for their clubs/teams in both an individual local club capacity and team, national capacity.

In the absence of, or until the formation of a club/team structure, all players will be able to take part individually in a single universal game pool or any number of standalone pools on offer with the basic restriction of one game per player per pool.

Any/all competitive single event could be used to determine a player's skill ratio for use in the calculation of a PSF.

Scores from all players taking part in a universal event are combined to calculate an event average score for PSF purposes. (Using a standard scoring matrix and standard game format)

With every player only allowed a single game entry in competitive sport and sports gaming events and employing the exact same format throughout a very useful PSF can be calculated.

Although it is provided for that a PSF can be calculated using as little as one event an initial PSF will be calculated after (x) events (proposed 5 competitive player game scores, roughly a month to accumulate if events are staged once a week)

The PSF should be calculated on a regular periodic basis (could be after every event, weekly, monthly or any other interval as well as ad hoc calculations and adjustments) but designed for regular and frequent updates to keep ability ratings and allowances relevant and credible.

A PSF could be a whole rounded figure or un-rounded using any number of decimals but for greater player differentiation, un-rounded, using two decimals are recommended. In any PSF aided competition with large numbers of players taking part it makes sense to have a higher degree of player differentiation to determine winners and placed contestants to reduce multiple shared awards and dividends, especially where pari-mutuel style dividends are not provided for

When a PSF is calculated and/or used in a wagering application or a simultaneous wagering/gaming application where players are allowed to enter multiple betting lines it is proposed that only the best event score will be used for calculation purposes to prevent and discourage possible manipulation of the PSF. In a pure wagering application it is further advised that the PSF should be re-calculated and updated daily between events to ensure the integrity of ability ratings, pools and dividend payments.

### Player Private Challenges

As in any sport there can usually only be one or at best a few winners and placed finishers in any competition or event, but by introducing private challenges, players will have the opportunity of enhanced competition and additional winning opportunities even when not in contention for official top honours, other honours or accolades.

Side bets in sport are admittedly nothing new, and is not claimed, but formalising it with a standard competitive game format for measurement and in an original supported and managed structure is completely unique. This invention includes the formalisation of this feature from an organiser/operator/coordinator as well as a system and rules perspective to provide a unique framework and suitable platform for sanctioned player private challenges.

This invention includes original additions and enhancements to private challenges that will provide additional functionality to players and provide a unique dynamic structure within which these challenges could be offered and managed.

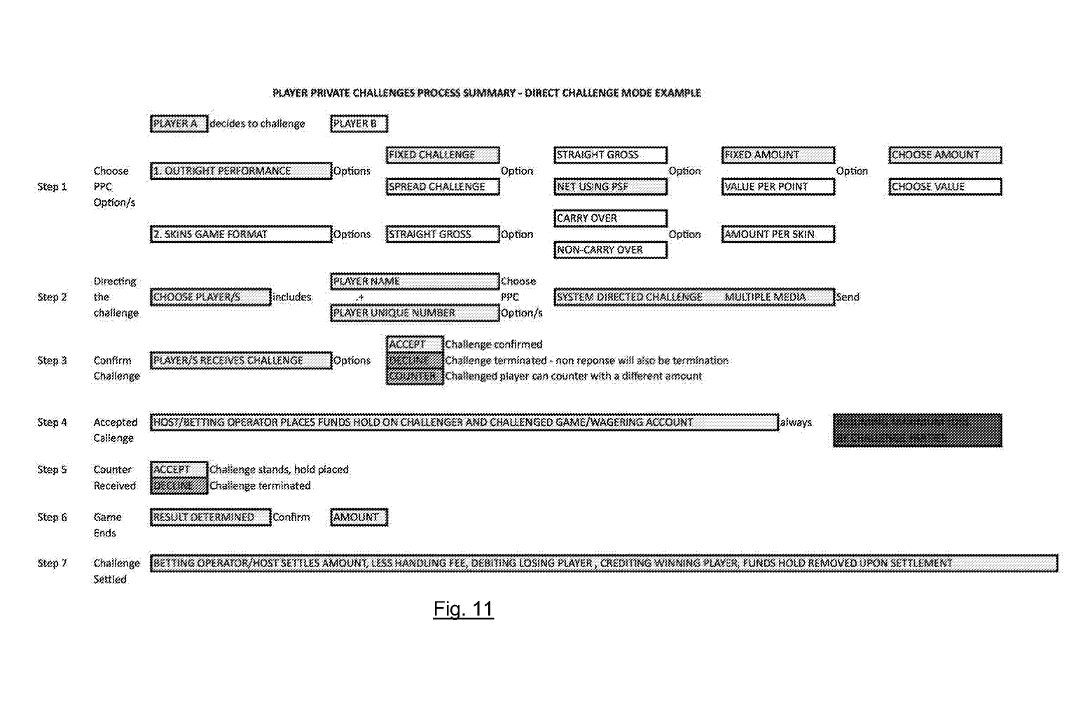

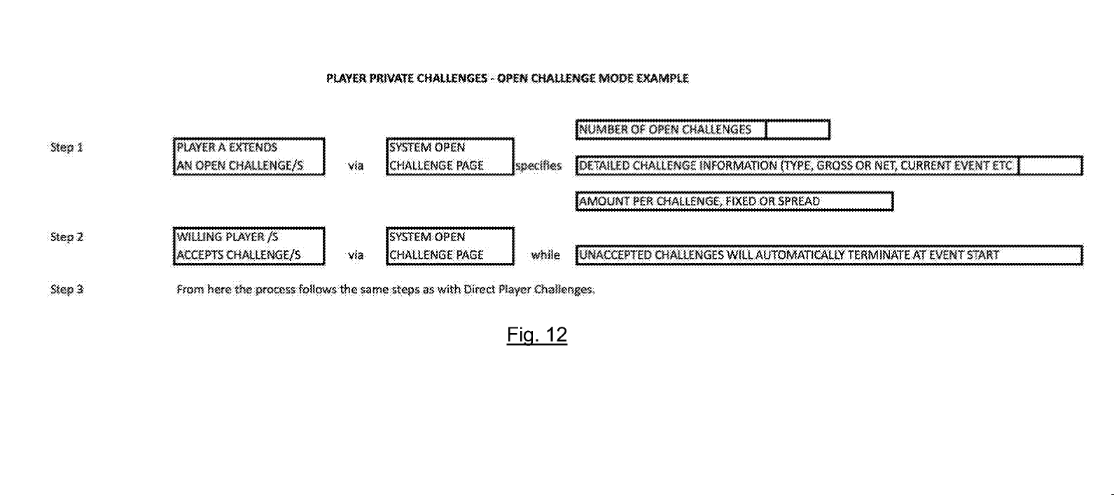

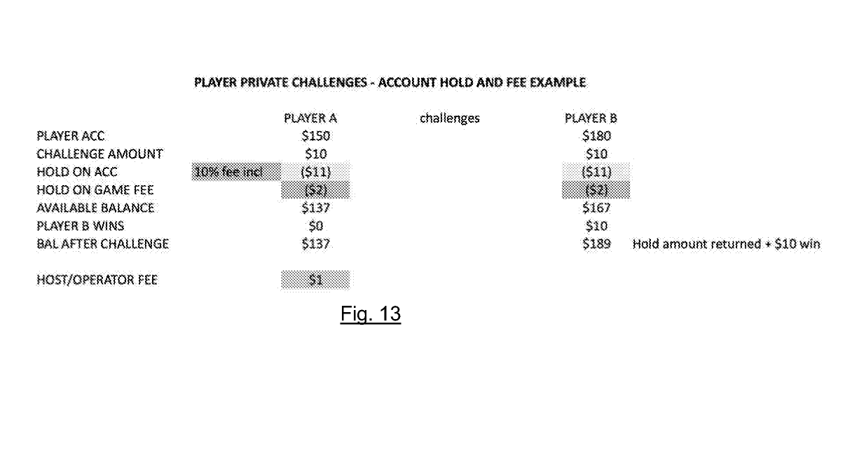

In an embodiment of this invention it is proposed that the licensed organiser/operator/coordinator will facilitate the placement and settlement of challenge wagers and standardisation of rules of official player private challenges by providing this as an Equine X game format and add-on system feature with all or some of the following characteristics:
Players will be able to challenge other players directly by selecting specific registered players (using their unique registration number and/or other identifying characteristics) and specifying the amount of the challenge and further selecting fixed bet or spread bet or any other provided type under challenge options (FIG. 11)
Open challenges can be made via an indirect system with invites placed on a challenge page or pages giving any other player the opportunity to accept the challenge as offered, fixed or spread or other provided type (FIG. 12)
The challenge function will include the following system options: accept, decline or counter or any other variant of these options in direct challenge mode, and accept and decline (no counter) in open challenge mode (FIG. 12)
Non-response is an automatic decline as challenges will require acceptance and will lapse if not accepted before the start/close of the specific challenge event
No maximum challenge amount subject to available balance on player accounts unless the controlling body deems it appropriate to impose an overall or specific challenge limit or unless it is a regulatory constraint
An automatic hold will uniquely be placed by the organiser/operator/coordinator on managed player account funds allocated for challenge purposes (FIG. 13)
The organiser/operator/coordinator will manage challenges and execute challenge payments in return for a percentage or fixed handling fee per challenge (claim) which could be paid either by the winner or loser subject to a pre-acceptance option (claim) or a standard pre-determined option or for zero charge as a free service
If the fee is to be paid by the winner it will be deducted from the winning amount (amount less fee to be credited to the winning player's account), and if the fee is to be paid by the loser it will be added to the losing amount and deducted from the losing player's account and will be factored in to the hold placed on the account
Provision is also made for this fee to be a separate deduction based on any predetermined formula or flat amount
Further to this all party or both party fee deductions are also catered for in the design
Fees are to be void where challenges are drawn or no winners can be determined which would also include events concluded pre-maturely or cancelled for whatever reason
Provision is also made for player spread betting challenges on a value per point basis with the funds hold assuming maximum loss plus fee at all times, which is the difference between the maximum matrix points on offer and zero (FIG. 23)
Provision is made for challenges to be determined on an outright gross points performance or a skills factor inclusive net basis option where practical to do so
Provisions are also made for standing challenges between two or more players which will automatically be generated after each event by means of an on/off option function in the system

The above points cover the basic challenge methodology and system and organiser/operator/coordinator requirements and compensation but it also makes provision for any further player challenges throughout an event or series of events or a tournament/competition or extended tournament/competition.

Players can also challenge each other on any aspect that forms a part of the relevant game or any aspect particular to the current game with no limitation subject to it being catered for in the system provided for game play, recognised by the licenced organiser/operator and approved from a regulatory perspective.

Possibilities for example are:
The highest points total between different legs of the game
The highest points after a selected number of legs
The most points for specific pre-selected legs of the game
The most points in a single leg of the game
The most points from a specific starting to a specific finishing point in the game

The challenge function is however not limited to the above but covers any possibility as long as it is part of the current game in play or a specifically identifiable and offered future game or at the start of a tournament, competition or series event.

With challenges being cash onerous because of the hold on funds it is not foreseen that players will challenge far in advance, but the likelihood is at all times catered for.

A further type of player challenge that is catered for in this invention is skins challenges, which is a well-known format in the world of golf.

The standard Equine X game design lends itself to the inclusion of skins challenges as it has available sub sets (different legs of the game) of results forming part of an overall event or series of events and a differentiated reward structure (matrix) per leg. This is something that has previously not been available in racing and could thus not be offered by betting operators using traditional methodology.

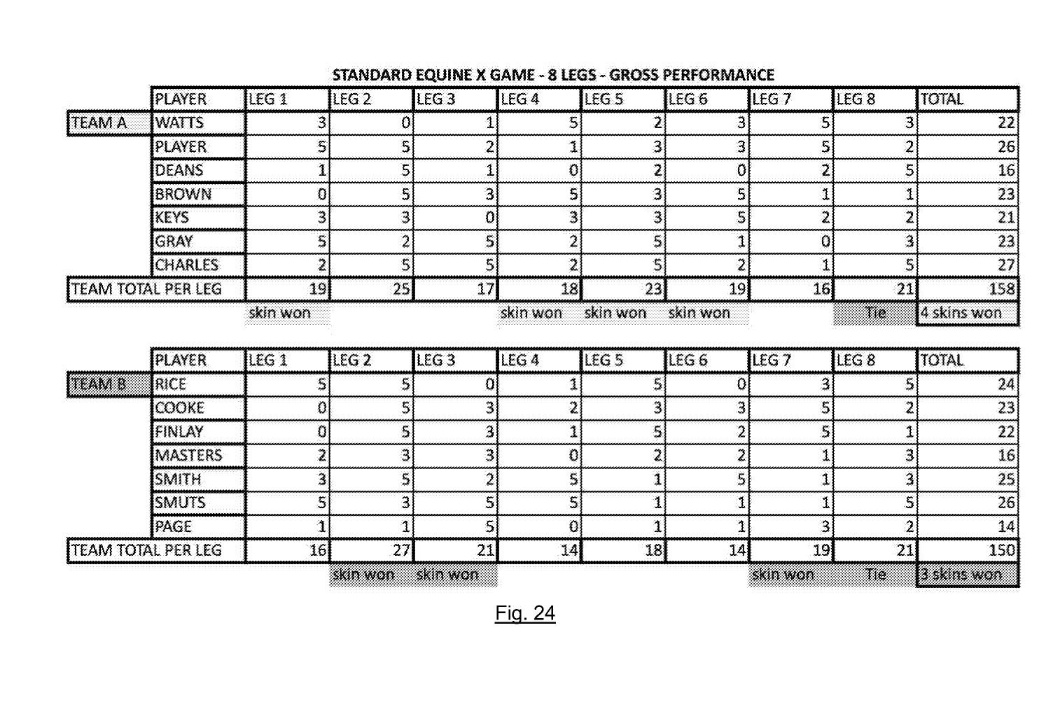

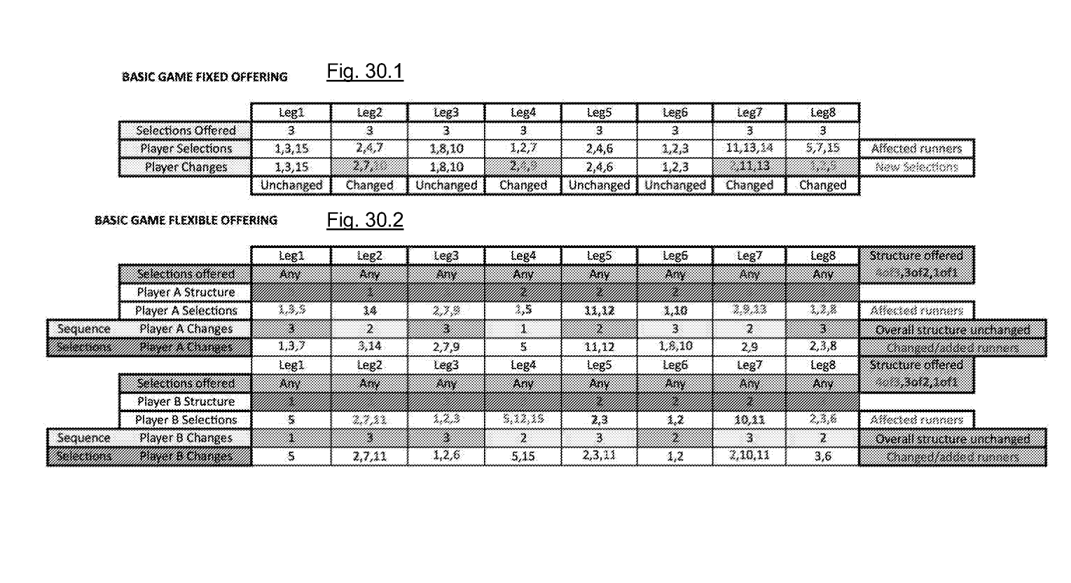

A number of underlying features of this skins format is in fact unique and will be highlighted in the format summary below:
Individual and team skins challenges are catered for
Players will be able to challenge other players and specify the monetary value per skin that they wish to play for
Each leg of a game will apply in a standard skins challenge with skins carried over to the following leg if scores are tied in the preceding leg or alternatively forfeited if not won outright
Apart from equal value skins a further option will be that skins could have different values in different legs and could be in the form of a staggered increase as the game progresses or any other form of pre-defined or player agreed changes in skin values, subject to the production version of the game and organiser/operator catering for the intended option and having regulatory approval
The highest score in any leg will win the skin or skins on offer in the relevant leg
Challenges will be settled after the final leg of the game with the operator/administrator/organiser responsible for managing the process
Skins not won in the final leg of the game will not be carried forward to a future game and will merely be forfeited but could also be settled by any pre-determined arrangement or option
Players will be able to issue one on one challenges or team on team challenges
Unofficial teams are player originated before the start of a game and all challenges subject to being timeously directed at an opposing team or teams
Teams can be any size that is catered for from a technology and system perspective and sanctioned by the organiser/operator but needs to oppose teams of an equal number in skins challenges and within operator/administrator/organiser system rules and capabilities (FIG. 24)
Team members will not have access to each other's selections until the start of the game event of the day which could result in team members having identical, similar or shared selections. The fact that team members are also simultaneously individual opponents in the daily event necessitates that selections are not known or revealed beforehand and that selections will be treated as confidential
In standard team skins challenges only one highest score between (x) number of players in the team will be used to determine the winning team in a particular leg of the game
An alternative challenge option is provided for in which the aggregate/total team score per leg will determine the winner of the particular leg of the game (FIG. 24)
In team challenges it would be possible that any combination from the team could be used to determine the winner of a leg as long as it is predefined, catered for and accepted before commencement of the event (for example top (X) scores, highest+lowest score, lowest (X), two highest+two lowest or any other conceivable or possible combination) (FIG. 29)
Another skins option is that skins will not be carried forward and only skins won outright in any particular leg will apply
All or some of these options could be made available to players in the game system for pre-selection before the start of any game
Skins challenges will again be managed by the operator/administrator/organiser from a system perspective as explained in an earlier part of this application
Maximum loss is always assumed which means that any player must have enough funds in their operator/administrator/organiser managed player account to cover this amount, plus fees, as a hold will once again be placed on the maximum potential loss until final payment of the challenge is effected (FIG. 23)

Including player challenges as part of a game will make involvement in the sport or game more exciting, competitive and potentially rewarding for players and allow the operator/administrator/organiser access to a growing source of additional funding (commission or fee) for racing and/or extra revenue

Challenges will be completely voluntary and is a complementary offering for registered club/team members looking for additional in game fun, and also a source of bragging rights and social-interaction, during game play.

This feature will also enable all players with varying levels of ability to be more competitive whilst acquiring skills as it makes it possible for them to challenge other players of similar, lesser of greater ability (based on PSF rating) which will make the learning process and participation far more enjoyable.

These add on features are meant as a form of additional entertainment whilst competing and will make games more meaningful for all participants not in the running or in the running for top daily finishes and honours. It offers a creative way of providing every player with a more competitive and enjoyable experience and an opportunity to measure progress at multiple levels simultaneously.

The formalised player private challenge feature will make it possible to have a large number of winners in each event and with winning a powerful motivator for initial and extended involvement, would be a highly effective innovation.

### Player Private Challenges—Continued

With specific reference to the use of the (PSF) in player private challenges provision is further made for players of different ability to compete on pure gross terms but with an odds differential compensating for the difference in their relative ability. The odds can be calculated using the margin of the difference in relative ability expressed by the official PSF (rounded or unrounded) of two opposing players or a percentage of the difference or any formula to derive at a set of odds reflecting the relative difference in ability of the players challenging each other.

For example if one player is rated+2 and another −3 the difference of 5 could represent odds of 5 to 1 in a private challenge entered into on straight gross terms. It could also be decided that a set percentage of the difference would be applied to calculate the odds for instance 50% of the difference which in this case would produce odds of 5 to 2 or in other words 2.5 to 1. (FIG. 35)

In another embodiment of this, player odds could also be established by mutual agreement between players in their individual player private challenge. Whatever they agree on and subject to it being provided for in the system, will be locked in before commencement of the game and will once again determine the extent of the monetary hold that will be placed on the players playing accounts. In this instance one player will have a much larger hold placed on his/her account than that of the opposing player as odds inclusions are one directional (FIG. 35).

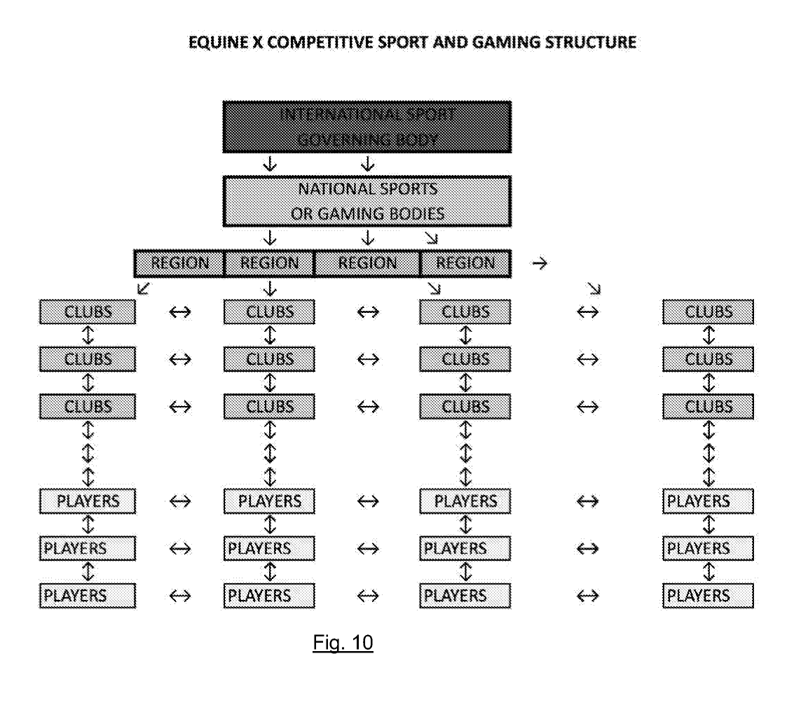

### Formal Sport Governing Structure and Participation Rules (FIG. 10)

As a sport or game should always be firstly about the players the structure will be discussed from this starting point. Each person interested in playing will need to register with a club or a team, depending on the specific structure implemented, before they will be able to compete. A unique membership number will be provided to be used in all competitive events and challenges as a player identifier. This unique player number will contain details of country, club and the individual for playing and challenge purposes.

Registration will also involve setting up a player monetary account from which game fees, challenge fees, general fees or wagering amounts will be debited (deducted) and prize money or dividends returned to the account with the process to be managed by the operator/administrator/organiser in an embodiment of this invention.

The amount of detail needed upon registration will depend on country requirements as it relates to FICA as well as the operator/administrator/organiser's own requirements.

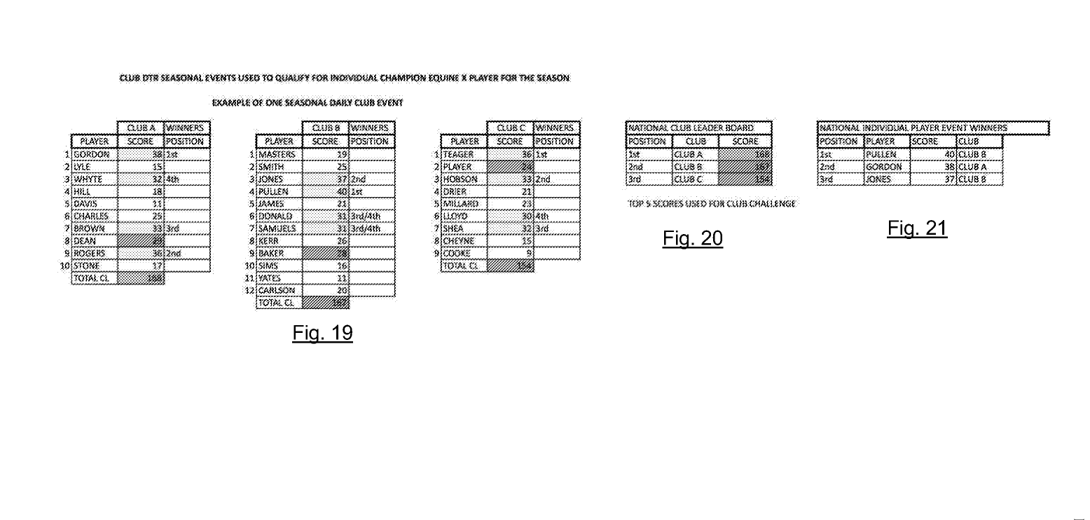

Clubs are the key component of the Equine X competition and sport structure and are comprehensively catered for in the majority of proposed competitive formats. Club events will comprise of members (players) in individual clubs competing against each other within each club, clubs competing against other clubs in the competitive structure, mostly nationally, and all club members competing individually against other club members nationally. The format is designed to uniquely cater for most events simultaneously from single game involvement (claim) but with extensive provision for additional or stand-alone events at any level of play. (FIG. 19, 20, 21)

Each player will only be allowed single membership of a club or team and no multiple club/team memberships will be allowed, although the possibility is catered for. During competitions and competitive events each player will only be allowed a single game entry, but multiple entries could be allowed in wagering and exclusive wagering pools.

Club/team membership will be open to all but with age limitations to be determined by the governing body or operator/administrator/organiser subject to country or state regulations. Players younger than 18 (or other relevant age depending on applicable laws) where legally allowed to participate will need the consent of parents or at least a parent or guardian to be able to play. These players will not be allowed to wager but could be eligible for prize money and prizes as well as merit team representation, either individually or in a team in Equine X sport or sports gaming events.

The number of clubs per region will be determined by the operator/administrator/organiser in conjunction with the sport governing body or unilaterally where no umbrella governing body exists or is not yet formed. The same applies to the number of geographical or zoned regions locally, nationally or internationally and these could be provinces, states, counties or any other geographical demarcation.

Provision is made for these numbers to be reviewed and adjusted from time to time either periodically or on an ad hoc basis by the organiser/operator/coordinator/controlling body.

Each club/team will be identified by means of a unique code that will be incorporated into a player's individual player identifier for taking part in any competitive events. An international governing body is also provided for, once national bodies have been established in enough countries, to warrant international competition (Could also be a controlling betting operator).

A single operator/administrator/organiser could also offer the game or sport in its entirety either nationally or internationally in the absence of multiple regional or national operators/administrators/organisers.

The licensed operator/administrator/organiser will be entitled to determine the minimum and or maximum number of members per club/team if need be and these could be revised and adjusted periodically or on an ad hoc basis.

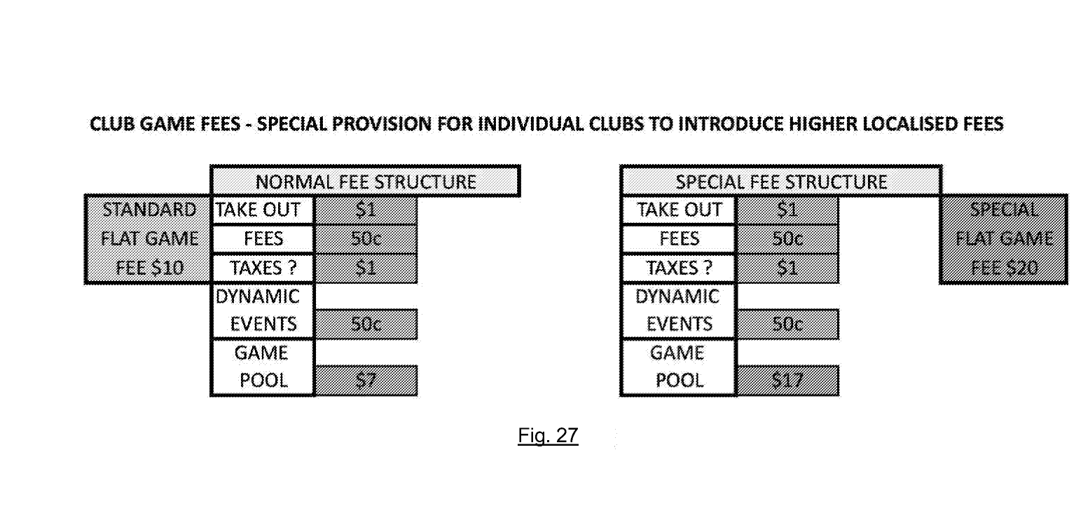

The standard flat game fee will also be determined by the licensed operator/administrator/organiser but individual clubs will have the authority to charge a higher game fee to club members but only with club member 100% (or depending on organiser rules (x %) majority) consent. (Special rule at only club level) Dynamic deductions and fees will be charged at the standard determined official game rate but it is provided for that individual clubs have the right to charge higher game fees to create bigger localised club pools. (FIG. 27)

In an embodiment of this invention a licensed operator/administrator/organiser will also be entitled to determine standard game fees, extra competition game fees, prizes and prize money, pool percentages, administrative and funding deductions and the number of reward positions and percentages or fixed amounts applicable or any other costs that might be applicable as well as periodic increases in any standard fees.

The operator/administrator/organiser will also have the responsibility of managing skill factor calculations and updates, managing player private challenges and maintaining an adjusting rules and informing players with regards to these issues. This includes amongst others having a separate club skill factor ladder, regional ladder and a combined national and international log, where applicable.

The operator/administrator/organiser will be required to maintain and manage player accounts and payment systems, player registration as well as providing tournament and competition information, scheduling events and providing event form guides and the daily update of essential information and all relevant information.

The operator/administrator/organiser must provide and maintain the system that players will need to access to log their daily and other entries. This system should allow all players access to relevant information needed to compete as well as general information required as club/team members.

Provision is made for all of these function to be third party outsourced but with the operator/administrator/organiser retaining the responsibility overall.

In return for managing systems and structures and staging events, competitions and tournaments an organiser/operator/coordinator will be entitled to fees and revenue from Equine X, as a sport, sports game or a wagering event. (FIG. 16)

Although Equine X is aimed at club and individual competition a single national or universal structure could also be utilised throughout for all competitive game play and competitions.

### Planned Competition Structure

The competition structure makes provision for multiple competitive formats and events that will be introduced as development of the game or sport grows.

The structure specifically makes provision for individual and team events, events with gross performance and net performance recognition and reward utilising the unique player skill factor format, dynamic team representation events and merit selection based representative events for both teams and individuals. Provisions are made further for single, multiple, extended and dynamic longer term events utilising any of the above formats.

A unique aspect of the competition structure is that it makes provision for a single event offered by the operator/administrator/organiser to be entered by club members (players) and then utilised in multiple simultaneous competitive events (claim). For this purpose the game fee structure will make extended provision for sub or divsional deductions for the different underlying events from a single game payment (claim). Special fees or ad hoc fees are also provided for and could be utilised for once off events or special reward pools.

A typical example specifically being catered for is that a single event will produce individual club winners with provision for gross and net performance reward and recognition at local level, the same at national or other level as well as deductions for seasonal reward of winning clubs and an annual season finale for individual top contributors.

Player private challenges are comprehensively catered for in the competition structure for both sport and sports gaming and potentially a wagering application. Some events, formats and awards already specifically provided for in this invention:
Seasonal inter-club/team league tournament (using DTR)
Regular periodic club day events which will also double up as inter-club events during the pre-determined season
Annual, once a year individual club championships (gross and net (PSF) recognition) to be staged at each individual club for local members only
Annual individual knockout competition with qualifying event or events to determine the knock out final field, gross and net event/s planned
Annual team knockout competition with qualifying event or events, gross and net event/s planned
Inter-regional annual competition/s using merit based representative selection for the picking of individuals to represent the regional team
Internationals with provision for merit based representative selection
Internationals utilising DTR
Annual club straight knock out tournament utilising DTR
Top club, club players and regional, national and international player's awards and trophies

Details around event specifics are not mentioned at this point in time as numerous options as above already exist, and more are being developed continually, with this invention application concentrating on the unique format, structure, features and system requirements rather than specific competitive events.

### Exclusive Club/Team Member Benefits

An exclusive club/team member only regular pool wager is planned with provision for main gross and consolation net dividends or full gross or full net dividends.

Only club members will be allowed to participate in Equine X pool betting which can be offered by the operator/administrator/organiser at any time on any events deemed appropriate as separate stand-alone and voluntary events.

This exclusive pool or pools will not be limited to only sports gaming events and could be offered daily on single or multiple events, including pure wagering events, at the operator/administrator/organisers discretion.

Although pools will be exclusive to club members, membership of clubs will be open to anyone not excluded on the grounds of age or any other legitimate exclusion. Membership is required to ensure that competitions and pools are regulated subject to operator/administrator/organiser or club and other sporting code rules.

The reason for ring fencing a pool specifically for club/team members is to provide exclusivity, to keep professional punters out to ensure that pools are not manipulated and to ensure pool integrity at all times, provide members with a better and more enjoyable winning opportunity and to offer specific penetration monitoring from a key marketing perspective.

An exclusive member only pool will also provide an opportunity to effectively cap maximum bets or the number of bets where deemed appropriate or required (from a socially responsible wagering point of view) and to introduce member friendly pool rules that will offer additional benefits to members.

### In-Game Accessibility and Control

In some embodiments of the Equine X invention players will be able to access their selections prior to the start of the game, as well as further access to any leg of the game or wager, with an opportunity to make alterations or changes to their selections throughout the event, as it unfolds.

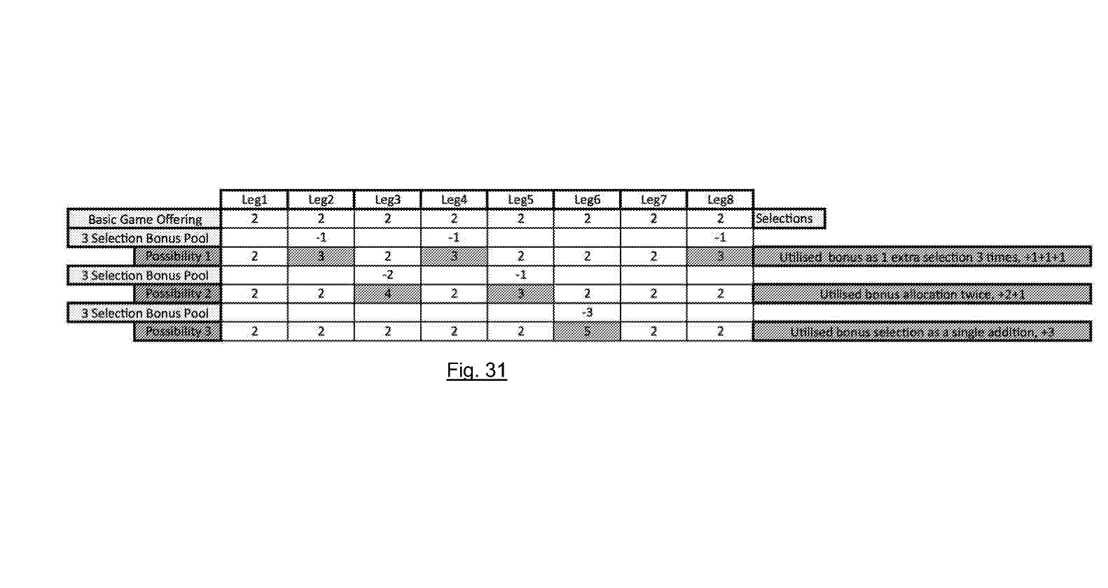

What is provided for are a number of accessibility options of which the most basic one will be the ability to change the selected runners/contestants purely on a one for one basis in the submitted game selections, subject to the number of selections offered (FIG. 30.1). There will either be a limit on the number of times selections can be changed or no limit imposed on the number of times a player can change with the only restriction that changes can only be effected until just prior to the start of any leg of the game.

A further provision in terms of accessibility will be the ability to swop around the number of runners/contestants in a particular leg or legs subject to the permutation/combination structure of the game or wager based on a like for like overall structure. (FIG. 30.2) For example, if a player is allowed a combination/permutation of 3 legs of 2 runners and 4 legs of 3 runners and one leg with a single runner the entire game selection can be re-arranged once chosen as long as the end result mirrors this basic layout. Thus a player combination of runners of 3×2×1×2×3×3×2×3 in an eight leg game could be switched after for instance 2 legs to 3×2×3×3×1×2×3×2. It is clear from this example that the player has retained the overall offered structure but in a different sequence in the game and clearly once legs have been run those legs cannot be changed around, only the remaining structure whilst retaining the basic offered layout. Prior to commencement of the first leg of the game the entire structure could be rearranged.

In another embodiment of this invention the addition or reduction of runners in legs of the game is unrestricted as no pre-arranged structure is offered, subject to the number of runners available for placement throughout the game. This would for instance be applicable in an embodiment of the game where players are allocated (X) total number of runners before the start of the game that can be utilised in any quantity throughout the event, subject to a leg having at least a single allocated selection. See advanced/managed runner pool described in a further section.

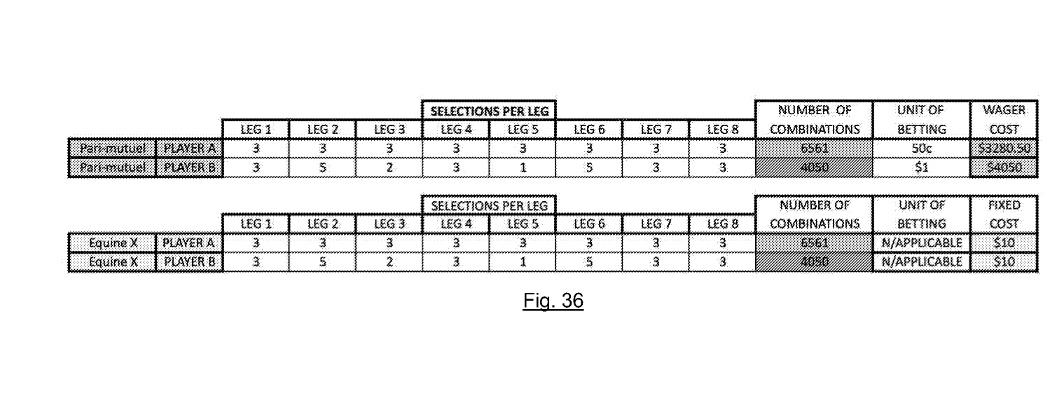

This invention is radically different from a pari-mutuel defined structure where a permutation is defined as a certain number of different combinations or betting lines, and where the cost is determined by the number of betting lines multiplied by the unit of betting. In longer formats this is a very costly methodology for players where the addition of only a few selections could add large amounts to the overall cost (FIG. 36).

In this invention game costs are intended (not restricted) as a fixed cost component determined by the organiser/operator, not variable and where a certain combination structure is a set offering rather than a formula determined player cost. This will allow game play to be much more affordable for players and for more tailored to game requirement combinations/permutations to be offered to contestants (FIG. 36).

Tiered costs are provided for in Equine X but not necessarily subject to any mathematical formula, as costs are mostly viewed and determined from an affordability perspective and as optimal contest criteria.

In this invention an event can be defined as a single leg of or a number of predefined legs of a game, contest or wager, or multiple events making up a specific longer term competition or wagering offering.

With regards to accessibility, further provision is made for a limited or unlimited number of changes subject to a predetermined formula and/or format. All changes will be allowed until just prior to the off of the following leg of the event or series of events and will or could be repeated or offered for each consecutive or upcoming leg. The first leg will only be closed for changes at the start of the first leg of the offered event. To protect players from system and technology limitations, faults or temporary accessibility issues caused by software or hardware, which include network servers or any unforeseen event or circumstances, all players would be required to make a full or sufficient partial selections to have a qualifying game or wagering line before the start of the first leg of the event. Changes would be allowed and facilitated thereafter within the rules or format of the game but in the event of non-accessibility or interrupted accessibility would ensure that players will have a valid predetermined selection to guarantee their continued participation in the wager or game. Under all circumstances it would be advisable to require players to provide a complete selection prior to the start of the first leg of the game to avoid the possible disappointment of an affected selection that cannot be changed for whatever reason or because of an unforeseen event. The system would be set up to either allow or not allow partial selections to be accepted at the onset of the game.

Provision is also made for selections to only be provided by players for each current leg just prior to the start of the leg but is once again not advised as many factors could prevent a player from posting his/her selections which will negatively impact the competitiveness of the player and their chances of success in the game.

To access the system and their selections players will need to log in with the necessary details (normally user name+password) and any additional log in requirements determined by the organiser/operator to ensure that selections cannot be compromised by external parties or other players in the game or wager. The onus for changes will in all instances reside with the player and an inability to effect a change or complete changes will not offer the individual any recourse against the party offering the game or wager.

In a stub based environment provision is made for a betting or game ticket to be updated by a tote attendant or dedicated resource, or the player or other in a self-service environment, and for a new ticket reflecting the changes to be issued to the player. In all instances the old ticket stub is to be cancelled and removed from circulation unless there is provision for multiple changes on a single ticket.

The ability to effect changes to selections throughout a wagering or game event will add vital functionality to put players in any of limited, comprehensive or complete control in a game and would add substantially to the playing experience of new, novice and experienced players. It would further add the vital elements of complete fairness and flexibility to participation with players having both the ability and means to react to any changes that they deem necessary or material.

### Advanced/Managed Runner Pool/Bonus Pool

The creation of accessibility and in-game changes and adjustments in skills based games or wagers have led me to the invention of a completely new pool methodology and future format.

This element of the invention is aimed at a game or wagering offering that could include but are not restricted to a standardised game format with fixed or variable selections offered at either no cost or a fixed cost or based on a variable cost formula which could be enhanced by the inclusion or offering of an additional bonus/advanced/managed runner/contestant pool.

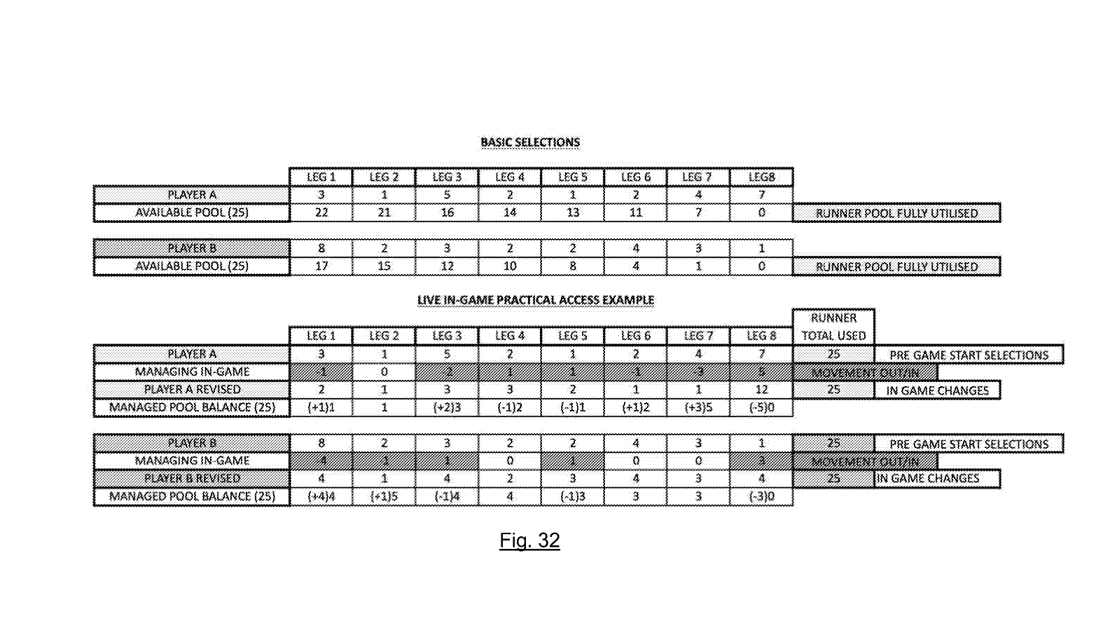

The created bonus pool will provide players with a number of additional, flexible selections over and above the fixed game structure and could be utilised in any leg of the game, either once off in a single leg or a number of times in a few legs or incremental as required or decided. (FIG. 31) In an eight leg fixed game offering a typical standard permutation/combination could be: 3×3×3×3×3×3×3×3 selections. A bonus pool of 2 additional runners could be utilised in a number of intended ways. For example in a one directional exit/out only bonus pool the game could look like this: 3×4×3×3×3×4×3×3. The player has thus utilised the bonus pool by adding 1 additional runner to 2 different legs of the fixed permutation offering as per his/her preference. Alternatively it could look like this: 3×3×3×3×3×3×3×5. In this instance the bonus pool was utilised in a single leg of the game. (FIG. 31) The size of the bonus pool (number of runners or contestant selections) and variable bonus offerings will be left to the discretion of the party licenced to offer the game or wager and will be offered as a customisable or configurable option, but the invention makes provision for any number to be offered.

The bonus runner pool could be one directional offered as exit/out based only as illustrated above with a draw down on the pool until it gets to zero, or (multidirectional) out/in, which will allow players to reduce the number of runners/selections in any leg of the game by removing them and then adding them to the bonus pool for use at a later stage in the game. This would be especially useful where multiple (X) selections per leg are offered as standard to players and they may wish to reduce this standard allocation in a particular leg or legs. In this example once again using an eight leg fixed permutation/combination it will work as follows: The standard runner selection structure will be 3×3×3×3×3×3×3×3. In this instance a multidirectional out/in bonus pool is offered starting with what could be any number of bonus selections. The player will be allowed to move runners around freely between the bonus pool and their game permutation structure and in any direction in legs of the game that are still to be contested. A possible starting combination could be 1×3×3×3×3×3×3×3. In this instance the player has moved two selections from leg 1 of the standard fixed permutation structure and they are not reflected in the permutation as they are now housed in the bonus pool for future allocation. Any unutilised bonus runners still in the bonus pool at the end of the game will be forfeited by a player and will not come in for any further consideration. The use of a bonus pool is intended for games with in-game accessibility as fixed inaccessible games could have bonus offerings that are predefined in the permutation/combination structure offered. (FIG. 14) For instance a standard fixed game offering of 3×3×3×3×3×3×3×3 with a bonus offering could look like this: 3×3×4×3×4×3×3×3. In this instance the operator/organiser has determined that players can choose 6 legs of 3 runners and two legs of 4 runners (bonus) and it will be at the discretion of the player in which legs the extra runners will be utilised at selection time. The operator/organiser could also specify that the extra selections will apply in specific, pre-determined legs, but this would not be advisable.

The bonus pool in accessible games could be reflected on an interactive page or similar or anywhere on the game screen or on a printed ticket as a number of selections available to players throughout the game and would automatically update or be updated after each utilisation (in/out, exit/entry) to reflect the current/available bonus pool position.

In another unique embodiment a player will receive or could purchase a complete pool of runners (Advanced/Managed Runner Pool) (FIG. 32), which can be allocated as the player sees fit throughout the game, with the provision that at least a single selection has to be made for each leg of the game prior to the start of the first event or leg, to protect the player against any potential inaccessibility. The number of selections that the player can choose from will always be equal to or more than the number of legs to the game or wager. A player will not be allowed to skip any leg and has to have at least a single selection in every leg of the game. The system could be set to force players to fulfil this obligation by not accepting a selection or a selection change without this criteria being met by the player. Provision is however made for leg by leg selections to be input prior to the start of each individual leg of the game.

The advanced/managed runner pool will put the player in the position of manager with selections to be allocated as required and with possibilities that include one directional draw down until zero is reached or multidirectional with the player able to move any number of selections in and out of legs via the advanced runner pool. A player could be provided with a runner pool of for example 25 runners in total to be utilised in any way over the legs of the game as long as the allocation adds up to 25 or less. A multidirectional offered pool will give players the further option of moving any selected runner that is scratched or withdrawn from a leg of the game back into the pool and can then either be substituted or not with an alternative runner or runners, at the players discretion (FIG. 32).

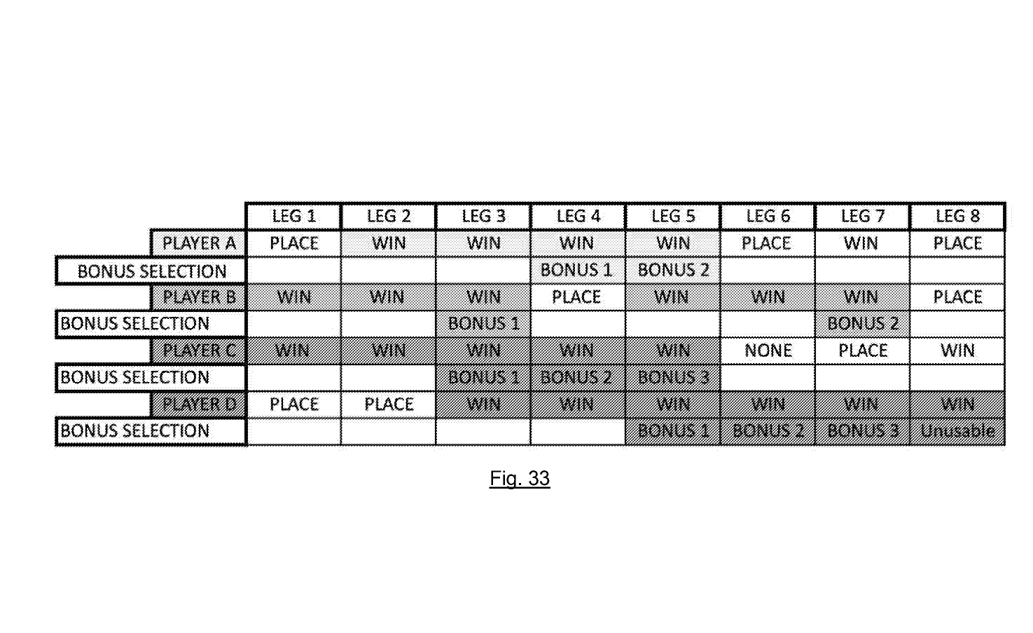

In a further unique embodiment players could earn bonus selections for predetermined achievements throughout the game which will increase the chance of winning or improving a player's results and will make the game more entertaining and interactive for players. For example selecting three consecutive winners or (X) number of winners in a row for consecutive legs could activate an extra bonus runner for use in the remaining legs of the game (FIG. 33). This could be a once off or a continuous offering throughout the game or an extended event and could either be capped or uncapped and could offer any number of bonus selections. (FIG. 33) Any predetermined achievement could qualify for added selection bonus offerings in a game and will make the game more exciting for players and provide the opportunity for a more interactive experience. Bonus offerings could also apply to correctly selecting longer priced qualifiers using a predetermined set of criteria. Examples could be correctly predicting winners in (X) number of consecutive legs or after correctly predicting (X) number of winners in total or when meeting or passing a predetermined points threshold or any arranged set of conditions needed to be met to qualify for bonus offerings. Specific legs of the game could also be set aside for bonus rewards qualifying. In summary, a player could earn any number of additional selections to be utilised as they see fit for achieving a predetermined set of conditions that will qualify for a bonus offering. In multiple event contests or competitions, bonuses in a certain phase of the contest (for example day 1 of a multiday event) could also only be usable in further phases of the event or in the very next phase of an event but this will be predetermined in the contest rules decided by the licenced operator/organiser.

Accessibility and the bonus pool methodology will give players comprehensive control prior to and during the game to provide the ability to respond to changing circumstances or incidents that could impact the outcome of the event. It also caters for players to merely have a change of mind for whatever reason and will make the playing experience more entertaining and enjoyable.

This element of the invention will also address another long standing issue in multi-leg games or wagering which is where runners are withdrawn or scratched during the event and becomes non-runners (as referred to earlier). In this instance players are normally given the tote favourite or other pre-determined runner as a substitute, which although a fair methodology, will in many instances not reflect the wishes and desires of the player. With this invention players will have the ability and opportunity to replace a runner or runners with another or others of their own choosing which will make for a much happier playing environment and a player preferred runner allocation. In the event of multiple scratched runners this invention will allow for every affected selection to be added to the bonus pool for re-allocation by the player or for direct substitution of every runner that has been withdrawn. Where players are unable to affect changes timeously the conventional scratching rule of replacement with the tote favourite will also be retained to give players another level of protection in a game.

### Increasing Winning Opportunities

Retaining the interest of players throughout the biggest part of a game or wager and preferably right throughout is a vital component to ensure a more entertaining experience and thus improved marketability and participation. Creating closer competition, keeping players in the running for longer and ultimately creating more winners whilst not watering down the offering or removing the potential for large pay outs, are critical product design elements that will impact on the successful future development and promotion of racing and other forms of wagering.

To this end the invention of multiple winning opportunities from a single game or wager through varying and variable simultaneous running formats will provide universal benefits and use. A single repetitive game fee and/or sponsorships and subsidies will mostly be used to fund multiple pools and prize money or dividends for both single events and extended multiple event rewards. The design makes provision for immediate event rewards, including in-game rewards (before completion) and completed event rewards as well as perpetual, seasonal and annual rewards. Provision is made for additional fees for special ad hoc events offered from time to time or as standard extra events on the annual, seasonal or periodic calendar.

This would provide for rewarding the overall winner or winners of the game with specific provision for shared rewards (net allocated pool divided by number of winners, partial pari-mutuel method) or a positional rewards structure based on the final player rankings or outcome of the game or wager. Additional sub rewards are provided for and could take the form but are not restricted to pre-determined sections of the game which could be even legs, odd legs, first half, second half or any predetermined number or selection of legs.

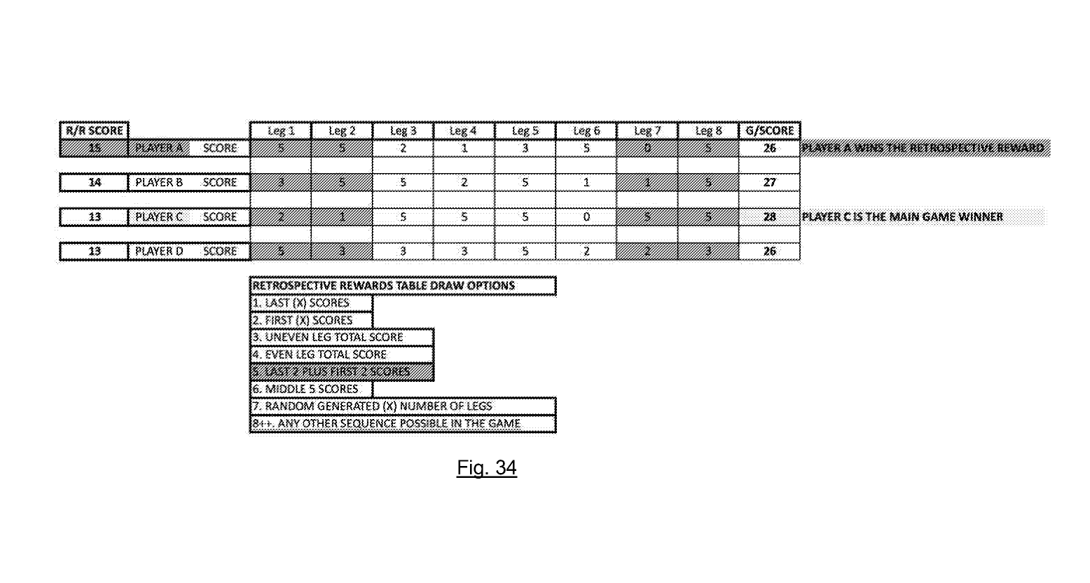

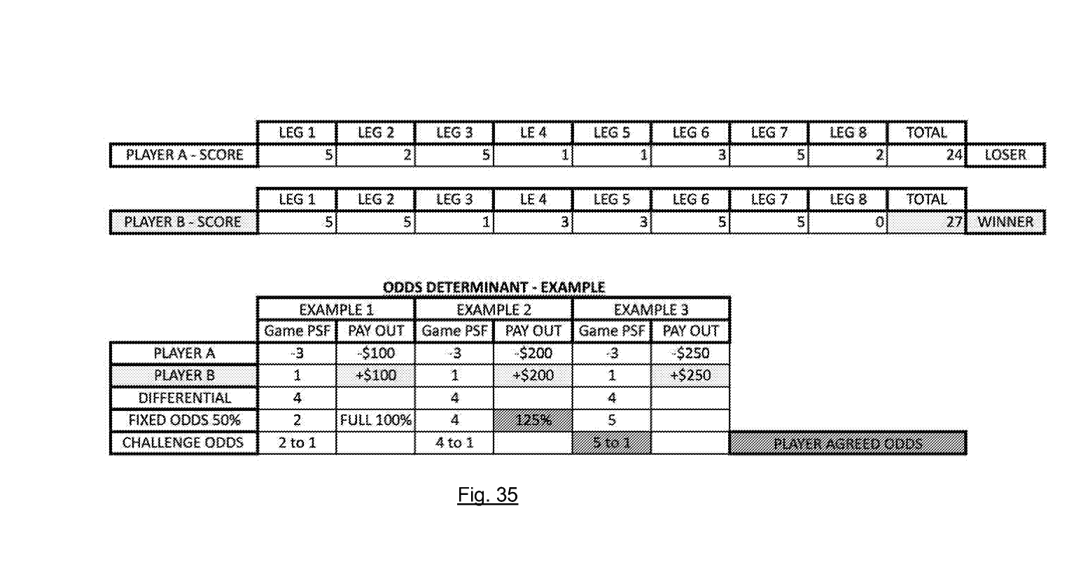

Special or bonus rewards (FIG. 34) could also uniquely be awarded retrospectively through random generation of the reward determinant after completion of the last leg of the game. In other words a draw or other form of random determination of sub or secondary rewards that will come into consideration only after completion of the game will present players with an equal chance of receiving an unexpected windfall. This will retain player's interest in the outcome of all legs (a stated objective) until after the event as this format and type of reward will only be generated post completion of the event. This is not to be confused with a lucky draw as a retrospective reward format determinant will decide on the format to be used to determine which player/s performed best within the specific parameters that will be rewarded by the draw. It is a skills based reward but on a randomly generated format for calculation of the winner/s (FIG. 34). A predefined percentage of the net pool will be pre-allocated for the purpose of this proposed reward where applicable. Provision is made for multiple winners, or a single or set number of winners using a predetermined count out methodology if required.

Winning is a very powerful motivator to initial and continued involvement which is why this invention has amongst others the objective to create more winners more often in a much more entertaining format.

### Fixed Odds Possibilities for Operators

The use of the average of all scores achieved by players in a game to determine a benchmark average for the calculation of player PSF's have a further use for betting operators offering fixed odds services. Betting operators could pre-calculate the expected daily average based on the perceived difficulty of the overall event and use it to facilitate fixed odds betting or spread betting against the estimate. The same could also be done for the expected winning score and used in a similar fashion. It is thus foreseen that Equine X could provide the industry with multiple new opportunities by having applications in pari-mutuel, contest based and fixed odds based events.

### Equine x Invention Summary

Equine X is a brand new multi-faceted gaming format that provides all the elements in a unique design to enable racing to be offered as a sport or sports game. It covers a wide range of aspects from an essential customisable standard game product to administrative and competitive structures, rules and system requirements, and adds unique playing features with original competition formats that cover everything from once off to short run and seasonal events with competitive and socially competitive options.

Every element in this invention has been combined to provide the racing industry with access to a very significant new marketing tool with which to promote racing amongst a completely diverse audience globally.

Equine X has been invented specifically to make racing more universally attractive by creating an exciting entertainment driven involvement with sport, sports gaming and wagering activities rather than only a narrowly defined pure wagering involvement.

Many elements of this invention would however not be out of place in a wagering only environment.

Part of the unique nature of this invention is the many completely new alternative game options and features that it presents as complete or add-on offerings in a completely original structure.

Although extensive provision is made throughout for wagering applications it is the competitive, social and educational angles of involvement in racing, areas largely neglected by the industry, which are given prominence and focus in this comprehensive new design.

1-48. (canceled)

49. A method of ranking a participants' level of expertise in a participation event in which multiple participants participate to predict an outcome of the participation event, which method includes
receiving outcomes from multiple previous events;
calculating for each event an average outcome amongst all participants;
calculating for each event for a participant a deviation between the participant's predicted outcome and the average outcome of the other participants;
obtaining for the participant an average of the total deviations between the participant's predicted outcome and the average outcome of the other participants of all competitive events.

50. A method as claimed in claim 49, which includes permitting any one of an administrator, game host, betting operator to select only certain events in a series of events for calculating the average amongst all participants.

51. A method as claimed in claim 49, in which a participant's level of expertise is expressed as a calculated ability factor for use as an ability allowance in the method.

52. A method as claimed in claim 51, which includes ranking the participants in a particular group according to the accuracy of their event predictions.

53. A method as claimed in claim 52, in which the ranking is valid for a predefined period.

54. A scoring method of a multi-leg wagering game in which a number of contestants participate in a multi-leg game, which includes:
defining a framework for a multi-leg wagering game;
receiving outcome predictions from a participant for each leg in the multi-leg wagering game, the outcome predictions for a particular leg being received before the start of the leg, the outcome predictions comprising predictions within the framework for the multi-leg wagering game;
permitting a participant to change their outcome predictions for legs in the multi-leg wagering game which has not yet started; and
accumulating a score according to the defined framework for the participant based on the outcomes of the legs in the multi-leg wagering game which has already taken place, the framework including any one or more of the number of legs per event, the number of runner selections per leg, the permitted position predictions per leg, the cost of a game, the flexibility of the structure offered, the degree of accessibility and bonus offerings and rewards included.

55. A scoring method as claimed in claim 54, in which the outcome predictions includes a prediction of the positions in which runners in the multi-leg wagering game will end.

56. A scoring method as claimed in claim 54, in which the pre-start runner selections in a particular leg are allowed to be substituted on a one for one basis.

57. A scoring method as claimed in claim 56, in which the number of contestants per leg is freely chosen by the participant within an overall limit on the number of participants in all the legs of the game or wagering game, as defined in the framework of the game or wagering game.

58. A scoring method as claimed in claim 56, in which a participant is permitted to change their outcome predictions for legs in the multi-leg wagering game according to a predetermined formula.

59. A scoring method as claimed in claim 56, in which additional runner selections are made available to participants for selection in certain preselected legs of the game.

60. A scoring method as claimed in claim 56, in which an overall pool of runner selections are made available for selection to the participant, who may then select any number of runner selections per leg, provided that at least one runner per leg is selected.

61. A scoring method as claimed in claim 56, in which the overall pool of runner selections available for selection by a participant is supplemented with additional bonus selections that may be used in the remaining legs, upon the participant achieving certain outcome predictions in some of the predefined legs of the wagering game.

62. A scoring method as claimed in claim 56, in which a bonus score is awarded to a participant upon completion of a wagering game, the bonus score being awarded for certain outcome predictions in certain predefined past legs.

63. A scoring method as claimed in claim 62, in which a bonus score is uniquely awarded retrospectively through random generation of a reward determinant after completion of the last leg of the game.

64. A method of facilitating a challenge between participants in a participation event in which multiple participants participate to predict an outcome of the participation event, which method includes
receiving from a first participant a challenge to the at least one other participant to determine an outcome of an event;
receiving a response from the at least one other participant to participate in the challenge, which response may include any one of acceptance of the challenge, declining of the challenge and raising a new challenge;
evaluating the event outcome in relation to the challenge from the first or at least one other participant upon completion of the event; and
settling the challenge between the first and at least one other participant.

65. A method as claimed in claim 64, which includes defining a particular amount that is challenged.

66. A method as claimed in claim 64, which includes include receiving from the first participant a challenge directed at a particular at least one other participant.

67. A method as claimed in claim 64, which includes include receiving from the first participant a challenge directed at no particular at least one other participant.

68. A method as claimed in claim 64, in which receiving a response from the at least one other participant includes assigning a declined status to a challenge which has not been responded to within a particular predefined time limit.

69. A method as claimed in claim 64, in which settling the challenge includes creating a credit commitment on the monetary transacting account described above.

70. A method as claimed in claim 64, in which accepting or making a challenge includes subtracting a predefined participation amount from a transacting account or incurring a hold on the value of the challenge on the transacting account.

71. A method as claimed in claim 70, in which settling the challenge includes the further step of paying and receiving payment from the respective participants' monetary transacting accounts based on the outcome evaluation.

72. A method as claimed in claim 64, which includes a continuous challenge between players for events in which they jointly take part.

73. A method as claimed in claim 64, in which a challenge includes any one or more of:
the highest points total between different legs in a series of events;
the highest number of points after a selected number of legs in a series of events;
the most points for a specific pre-selected number of legs in a series of events;
the most points in a single leg of an event;
the most points from a specific starting point to a specific finish point in an event; and
the most points after completion of all legs of an event or series of events.

74. A method as claimed in claim 64, which includes an accumulation of different challenges between the same participants.

75. A method as claimed in claim 74, in which the accumulation of different challenges in skins challenges includes accumulating collated event predictions from a number of participants arranged in any one of teams, clubs, geographical regions, countries and leagues.

76. A method as claimed in claim 64, in which the challenge includes the specification of the monetary value per challenge that the participants want to challenge.

77. A method as claimed in claim 76, which includes, if the challenge ends in a tie, that the challenge is either carried over to the next leg or is forfeited.

78. A method as claimed in claim 64, in which the highest score of a leg wins the challenge in the relevant leg.

79. A method as claimed in claim 64, which includes forfeiting a challenge if the challenge is not won outright at the end of a series of events.
